(19) United States
(12) Patent Application Publication
(10) Pub. No.: US 2024/0247944 A1
(43) Pub. Date: Jul. 25, 2024

(54) POTHOLE AND SPEED BUMP DETECTION BASED ON VEHICLE'S BEHAVIORS USING COMPUTER VISION

(71) Applicant: Volvo Car Corporation, Göteborg (SE)

(72) Inventors: Oswaldo Perez Barrera, Gothrnburg (SE); Gerardo Morales, Gothrnburg (SE)

(21) Appl. No.: 18/159,204

(22) Filed: Jan. 25, 2023

(51) Int. Cl. G01C 21/36; B60W 40/06; B60W 60/00

(52) U.S. Cl. CPC G01C 21/3691; B60W 40/06; B60W 60/001; B60W 2420/42; B60W 2552/00; B60W 2554/00

(57) ABSTRACT

Various systems and methods are presented regarding assisting an autonomous vehicle (AV) navigating a road when the road includes one or more road conditions that may be deleterious to the mechanical structure of the AV, operation of the AV, and suchlike. The deleterious road conditions can include a pothole, road debris, a speed bump, etc. Operation of a vehicle driving ahead of the AV can be monitored. The other vehicle may cause a pothole to be occluded from view by sensors onboard the AV, hence by monitoring operation of the other vehicle, e.g., maneuvering around/driving through a pothole, the AV can assess a size/location of the pothole and determine an action such as maneuver, slow down, change lanes, etc. The pothole location can be reported by the AV to enable other drivers and AVs to be aware of the pothole.

### TECHNICAL FIELD

This application relates to techniques facilitating operation of a vehicle to avoid or mitigate effect of an abnormality in a road surface being navigated by the vehicle.

### BACKGROUND

As autonomous vehicles (AV) start to become commonplace on the global highways and byways, operation of an AV during autonomous operation is a main concern regarding AV implementation. AVs have a variety of sensors and cameras onboard that can be utilized to determine a road condition that is being, or about to be, navigated. For example, a road condition system onboard the AV can detect a pothole is up ahead by analysis of digital imagery received from a camera configured to capture road conditions. However, the ability of onboard sensors and cameras to accurately determine a road condition can be hampered when the field of view of an onboard camera is occluded, e.g., by a vehicle travelling in front of the AV.

Impeded operation of an AV can lead to damage to an AV during road navigation, passenger discomfort, and can increase the probability of the AV being involved in an accident, all of which can further the resistance to AVs being adopted as a major mode of transportation.

The above-described background is merely intended to provide a contextual overview of some current issues and is not intended to be exhaustive. Other contextual information may become further apparent upon review of the following detailed description.

### SUMMARY

The following presents a summary to provide a basic understanding of one or more embodiments described herein. This summary is not intended to identify key or critical elements, or delineate any scope of the different embodiments and/or any scope of the claims. The sole purpose of the summary is to present some concepts in a simplified form as a prelude to the more detailed description presented herein.

In one or more embodiments described herein, systems, devices, computer-implemented methods, methods, apparatus and/or computer program products are presented that facilitate detecting and navigation potholes, street debris, traffic calming devices, and suchlike by a vehicle operating autonomously, or at least partially autonomously.

According to one or more embodiments, a system is provided that can monitor operation of a lead vehicle to determine the presence of a pothole, and suchlike, wherein the system is located on a first vehicle being driven at least partially autonomously. The system can comprise a memory that stores computer executable components and a processor that executes the computer executable components stored in the memory. The computer executable components can comprise a motion component configured to assess operation of a second vehicle driving ahead of the first vehicle. The computer executable components can further comprise a road condition component configured to identify a road condition based on the operation of the second vehicle. In a further embodiment, the computer executable components can further comprise a navigation component configured to navigate the first vehicle around or over the road condition. In an embodiment, the road condition is one of a pothole, a speed bump, or road debris.

In another embodiment, the computer executable components can include a camera configured to provide imagery of the second vehicle operating in conjunction with an algorithm configured to extract at least one of a license plate of the second vehicle, a manufacturer of the second vehicle, a model type of the second vehicle, a height of a structure on the second vehicle, a width of the second vehicle, or an axle width of the second vehicle.

In a further embodiment, the computer executable components can include an onboard vehicle database comprising license plates associated with manufacturers and models of vehicles. An onboard computer system can be configured to identify the license plate in the vehicle database; determine the model type of the second vehicle based on a model type assigned to the license plate in the vehicle database; and further determine at least one dimension of the second vehicle, wherein the at least one dimension is one of the height of the structure on the second vehicle, the width of the second vehicle, or the axle width of the second vehicle.

In a further embodiment, the road condition component can be further configured to determine at least one of a depth of the road condition below a road surface or a height of the road condition above the road surface based on a change in an alignment of the second vehicle relative to the road surface. In an embodiment, a camera can be configured to provide imagery of road being navigated by the first and second vehicle, wherein the road condition component can be further configured to execute an algorithm configured to analyze the imagery, identify at least a first lane marking on the road, and further determine a passable distance between an edge of the road condition and the first lane marking. The computer executable components can further include an avoidance component configured to determine whether the road condition can be navigated around based on the passable distance. The avoidance component can be further configured to determine whether the road condition can be navigated around based upon whether an axle width of the first vehicle is narrower than the passable distance. The avoidance component can be further configured to identify whether a lane is adjacent to the lane currently being driven by the first vehicle and, in response to determining an adjacent lane exists, steer the first vehicle into the adjacent lane to avoid the road condition.

In a further embodiment, the computer executable components can further include a communications component configured to transmit information compiled by the road condition component regarding the road condition, wherein the information is transmitted to a system remotely located to the first vehicle.

In other embodiments, elements described in connection with the disclosed systems can be embodied in different forms such as computer-implemented methods, computer program products, or other forms. For example, in an embodiment, a computer-implemented method can be utilized for identifying a road condition on a road being navigated by an AV, wherein the method can comprise monitoring operation of a lead vehicle, wherein the lead vehicle is operating ahead of the AV on the road. The method can further comprise, based on operation of the lead vehicle, determining the road condition exists; and determining a direction to drive by or over the road condition mitigating damage to the AV. The method can further comprise determining a dimension of the road condition based upon at least one of a change in alignment of the lead vehicle relative to a surface of the road or a vertical deflection of a structure on the lead vertical relative to the road surface, wherein the dimension is one of a depth of a pothole, a height of road debris, or a height of a speed bump. In an embodiment, the lead vehicle occludes detection of the road condition by one or more sensors located onboard the AV. The method can further comprise transmitting information obtained by the AV regarding the road condition to a remotely located system to facilitate informing at least one of another AV, driver, road maintenance department, global positioning system (GPS) provider, or police force of at least one of the presence or magnitude of the road condition.

In another embodiment, a computer program product can comprise a computer readable storage medium having program instructions embodied therewith, the program instructions can be executable by a processor, causing the processor to determine a road condition based on operation of a lead vehicle navigating a road being navigated by a first vehicle, wherein the first vehicle is driving behind the lead vehicle, and the processer is located on the first vehicle. The program instructions can be further configured to control the first vehicle navigating the road condition, based in part on how the lead vehicle navigated the road condition. The program instructions can be further configured to determine a magnitude of the road condition based upon at least one of a vertical displacement of the lead vehicle relative to a surface of the road or a change in alignment of the lead vehicle relative to the road surface. In another embodiment, the program instructions can be further configured to determine whether the road condition can be navigated while remaining in a current lane of the road, and in response to determining that it is not possible to navigate around the road condition while remaining in the current lane of the road, navigating the AV into an adjacent lane to navigate the road condition. In another embodiment, the program instructions can be further configured to transmit information regarding the road condition to a system remotely located to the first vehicle.

### DESCRIPTION OF THE DRAWINGS

One or more embodiments are described below in the Detailed Description section with reference to the following drawings.

FIG. 1 illustrates a system that can be utilized by an AV to detect and navigate a deleterious road condition, according to at least one embodiment.

FIG. 2 presents a schematic illustrating vehicles approaching a road condition, according to an embodiment.

FIGS. 3A and 3B present schematics illustrating various to determine various dimensions of a lead vehicle, while driving behind the vehicle.

FIG. 4 is a processed image of images received from one or more sensors of a road being navigated by various vehicles, with various lane markings identified, according to one or more embodiments.

FIGS. 5A-5C are schematics illustrating an AV monitoring operation of a lead vehicle to determine a road condition ahead, in accordance with one or more embodiments presented herein.

FIG. 6 illustrates monitoring of a lead vehicle and its alignment relative to a road surface 220, in accordance with one or more embodiments.

FIGS. 7A-7C present schematics illustrating utilizing an alignment of a vehicle relative to a road surface to determine a depth of a pothole, in accordance with one or more embodiments.

FIG. 8 illustrates a vehicle determining a size of a pothole relative to a lane width, where the pothole is not obscured by a leading vehicle, in accordance with an embodiment.

FIG. 9 is a schematic illustrating a vehicle navigating a speed bump or other structure that causes the vertical displacement of the vehicle to be elevated relative to a road surface, in accordance with an embodiment.

FIG. 10 is a schematic illustrating an information sharing operation being performed, in accordance with one or more embodiments.

FIG. 11 is a schematic illustrating a vehicle monitoring an existence/removal of a pothole over a course of time, in accord with an embodiment.

FIG. 12 illustrates a flow diagram for a computer-implemented methodology for controlling navigating a road condition in a circumstance where view of the road condition by onboard sensors is obstructed, in accordance with at least one embodiment.

FIG. 13 illustrates a flow diagram for a computer-implemented methodology for determining dimensions of a vehicle based upon license plate and/or make/model of the vehicle, in accordance with at least one embodiment.

FIG. 14 illustrates a flow diagram for a computer-implemented methodology for determining presence of a speed bump based on vertical displacement of a lead vehicle, in accordance with at least one embodiment.

FIG. 15 illustrates a flow diagram for a computer-implemented methodology for determining presence of pothole based on change in alignment of a lead vehicle relative to a road surface, in accordance with at least one embodiment.

FIG. 16 illustrates a flow diagram for a computer-implemented methodology for determining whether to navigate a pothole, in accordance with at least one embodiment.

FIG. 17 illustrates a flow diagram for a computer-implemented methodology for receiving information regarding a road condition to be navigated, in accordance with at least one embodiment.

FIG. 18 illustrates a flow diagram for a computer-implemented methodology for generating and transmitting information regarding a road condition, in accordance with at least one embodiment.

FIG. 19 presents a schematic of a computing environment in which the various embodiments of the embodiment described herein can be implemented.

FIG. 20 is a schematic block diagram of a sample computing environment with which the disclosed subject matter can interact.

FIG. 21 presents TABLE 2100 presenting a summary of SAE J3016 detailing respective functions and features during Levels 0-5 of driving automation (per June 2018).

### DETAILED DESCRIPTION

The following detailed description is merely illustrative and is not intended to limit embodiments and/or application or uses of embodiments. Furthermore, there is no intention to be bound by any expressed and/or implied information presented in any of the preceding Background section, Summary section, and/or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

It is to be understood that when an element is referred to as being “coupled” to another element, it can describe one or more different types of coupling including, but not limited to, chemical coupling, communicative coupling, electrical coupling, electromagnetic coupling, operative coupling, optical coupling, physical coupling, thermal coupling, and/or another type of coupling. Likewise, it is to be understood that when an element is referred to as being “connected” to another element, it can describe one or more different types of connecting including, but not limited to, electrical connecting, electromagnetic connecting, operative connecting, optical connecting, physical connecting, thermal connecting, and/or another type of connecting.

As used herein, “data” can comprise metadata. Further, ranges A-n are utilized herein to indicate a respective plurality of devices, components, signals etc., where n is any positive integer.

In the various embodiments presented herein, the disclosed subject matter can be directed to monitoring road conditions to mitigate probability of damage to a vehicle while navigating a road. Traversing a road condition (e.g., undulation(s) in a road surface) could damage the vehicle, unduly stress the vehicle occupants, damage objects being conveyed by the vehicle, cause loss of operational control of the vehicle which subsequently leads to an accident, and such like. The road conditions of concern are those which are an abnormality to the road surface, such as a pothole, debris on the road, a speed bump, a raised traffic circle, and the like.

While an AV may be configured to navigate and/or avoid road conditions that can be deleterious to the AV and/or operation of the AV, the likelihood of successfully determining a deleterious road condition exists when relying on onboard detection systems is reduced as vehicle speed increases. For example, the chances of detecting a deleterious road condition exists are greater at slower velocities than at higher velocities, and accordingly, given the reduced reaction time, the possibility of avoiding the deleterious road condition is reduced with an accompanying increase in likelihood of damage occurring when a vehicle navigates a deleterious road condition at higher velocities (e.g., at 70 mph/112 kph) than slower (e.g., at 30 mph/40 kph).

Various embodiments are presented herein, wherein one or more embodiments relate to determining a presence of a road condition before the condition is discernible to the AV, e.g., a pothole is not within a range of visual detection by one or more cameras onboard the AV. Further embodiments relate to determining a size of a pothole, road debris, and the like, based on monitoring behavior of another vehicle (e.g., a vehicle driving in front of the AV, aka a “lead vehicle”) as it navigates the road condition. In an embodiment, operation of a vehicle in front of the AV can be monitored, from which a depth of a pothole, height of debris, height of a speed bump, depth of a recessed speed bump, and the like, can be determined. In a further embodiment, the AV can monitor operation of a lead vehicle as it navigates a road condition and based thereon, the AV can make a determination regarding the magnitude of the road condition and whether it can be avoided. Further, the various embodiments present various approaches to detecting a deleterious road condition by systems and methods that do not entirely rely on analysis of digital imagery generated by an onboard camera(s), which can be beneficial when driving conditions can negatively affect operation of the onboard camera(s), e.g., while driving when it is raining, a wet road surface that prevents a depth of a pothole being known as the pothole contains water, and suchlike.

Regarding the phrase “autonomous” operation, to enable the level of sophistication of operation of a vehicle to be defined across the industry by both suppliers and policymakers, standards are available to define the level of autonomous operation. For example, the International Standard J3016 Taxonomy and Definitions for Terms Related to Driving

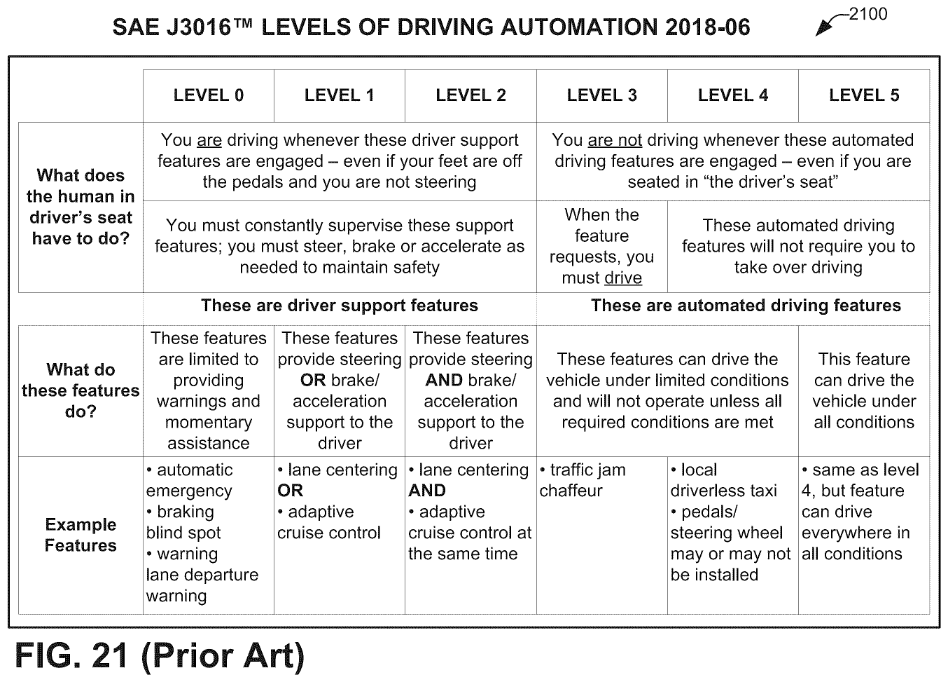

Automation Systems for On-Road Motor Vehicles has been developed by the Society of Automotive Engineers (SAE) and defines six levels of operation of a driving automation system(s) that performs part or all of the dynamic driving task (DDT) on a sustained basis. The six levels of definitions provided in SAE J3016 range from no driving automation (Level 0) to full driving automation (Level 5), in the context of vehicles and their operation on roadways. Levels 0-5 of SAE J3016 are summarized below and further presented in FIG. 21, Table 2100.

Level 0 (No Driving Automation): At Level 0, the vehicle is manually controlled with the automated control system (ACS) having no system capability, the driver provides the DDT regarding steering, braking, acceleration, negotiating traffic, and suchlike. One or more systems may be in place to help the driver, such as an emergency braking system (EBS), but given the EBS technically doesn't drive the vehicle, it does not qualify as automation. The majority of vehicles in current operation are Level 0 automation.

Level 1 (Driver Assistance/Driver Assisted Operation): This is the lowest level of automation. The vehicle features a single automated system for driver assistance, such as steering or acceleration (cruise control) but not both simultaneously. An example of a Level 1 system is adaptive cruise control (ACC), where the vehicle can be maintained at a safe distance behind a lead vehicle (e.g., operating in front of the vehicle operating with Level 1 automation) with the driver performing all other aspects of driving and has full responsibility for monitoring the road and taking over if the assistance system fails to act appropriately.

Level 2 (Partial Driving Automation/Partially Autonomous Operation): The vehicle can (e.g., via an advanced driver assistance system (ADAS)) steer, accelerate, and brake in certain circumstances, however, automation falls short of self-driving as tactical maneuvers such as responding to traffic signals or changing lanes can mainly be controlled by the driver, as does scanning for hazards, with the driver having the ability to take control of the vehicle at any time.

Level 3 (Conditional Driving Automation/Conditionally Autonomous Operation): The vehicle can control numerous aspects of operation (e.g., steering, acceleration, and suchlike), e.g., via monitoring the operational environment, but operation of the vehicle has human override. For example, the autonomous system can prompt a driver to intervene when a scenario is encountered that the onboard system cannot navigate (e.g., with an acceptable level of operational safety), accordingly, the driver must be available to take over operation of the vehicle at any time.

Level 4 (High Driving Automation/High Driving Operation): advancing on from Level 3 operation, while under Level 3 operation the driver must be available, with Level 4, the vehicle can operate without human input or oversight but only under select conditions defined by factors such as road type, geographic area, environments limiting top speed (e.g., urban environments), wherein such limited operation is also known as “geofencing”. Under Level 4 operation, a human (e.g., driver) still has the option to manually override automated operation of the vehicle.

Level 5 (Full Driving Automation/Full Driving Operation): Level 5 vehicles do not require human attention for operation, with operation available on any road and/or any road condition that a human driver can navigate (or even beyond the navigation/driving capabilities of a human). Further, operation under Level 5 is not constrained by the geofencing limitations of operation under Level 4. In an embodiment, Level 5 vehicles may not even have steering wheels or acceleration/brake pedals. In an example of use, a destination is entered for the vehicle (e.g., by a passenger, by a supply manager where the vehicle is a delivery vehicle, and suchlike), wherein the vehicle self-controls navigation and operation of the vehicle to the destination.

To clarify, operations under levels 0-2 can require human interaction at all stages or some stages of a journey by a vehicle to a destination. Operations under levels 3-5 do not require human interaction to navigate the vehicle (except for under level 3 where the driver is required to take control in response to the vehicle not being able to safely navigate a road condition).

As referenced herein, DDT relates to various functions of operating a vehicle. DDT is concerned with the operational function(s) and tactical function(s) of vehicle operation, but may not be concerned with the strategic function. Operational function is concerned with controlling the vehicle motion, e.g., steering (lateral motion), and braking/acceleration (longitudinal motion). Tactical function (aka, object and event detection and response (OEDR)) relates to the navigational choices made during a journey to achieve the destination regarding detecting and responding to events and/or objects as needed, e.g., overtake vehicle ahead, take the next exit, follow the detour, and suchlike. Strategic function is concerned with the vehicle destination and the best way to get there, e.g., destination and way point planning. Regarding operational function, a Level 1 vehicle under SAE J3016 controls steering or braking/acceleration, while a Level 2 vehicle must control both steering and braking/acceleration. Autonomous operation of vehicles at Levels 3, 4, and 5 under SAE J3016 involves the vehicle having full control of the operational function and the tactical function. Level 2 operation may involve full control of the operational function and tactical function but the driver is available to take control of the tactical function.

Accordingly, the term “autonomous” as used herein regarding operation of a vehicle with or without a human available to assist the vehicle in self-operation during navigation to a destination, can relate to any of Levels 1-5. In an embodiment, for example, the terms “autonomous operation” or “autonomously” can relate to a vehicle operating at least with Level 2 operation, e.g., a minimum level of operation is Level 2: partially autonomous operation, per SAE J3016. Hence, while Level 2, partially autonomous operation, may be a minimum level of operation, higher levels of operation, e.g., Levels 3-5, are encompassed in operation of the vehicle at Level 2 operation. Similarly, a minimum Level 3 operation encompasses Levels 4-5 operation, and minimum Level 4 operation encompasses operation under Level 5 under SAE J3016.

It is to be appreciated that while the various embodiments presented herein are directed towards to one or more vehicles (e.g., vehicle 102) operating in an autonomous manner, the various embodiments presented herein are not so limited and can be implemented with a group of vehicles operating in any of an autonomous manner (e.g., Level 5 of SAE J3016), a partially autonomous manner (e.g., Level 1 of SAE J3016 or higher), or in a non-autonomous manner (e.g., Level 0 of SAE J3016). For example, a first vehicle can be operating in an autonomous manner (e.g., any of Levels 3-5), a partially autonomous manner (e.g., any of levels 1-2), or in a non-autonomous manner (e.g., Level 0), while a second vehicle, a lead vehicle behind which the first vehicle is driving, can also be operating in any of an autonomous manner, a partially autonomous manner, or in a non-autonomous manner.

While one or more devices and/or systems are described below with reference to an AV, such as an automobile, the one or more embodiments described herein are not limited to this use. For example, the one or more embodiments presented herein can be employed to assist a driver who is operating a vehicle in non-autonomous mode and would appreciate notification of a location and magnitude of a deleterious road condition.

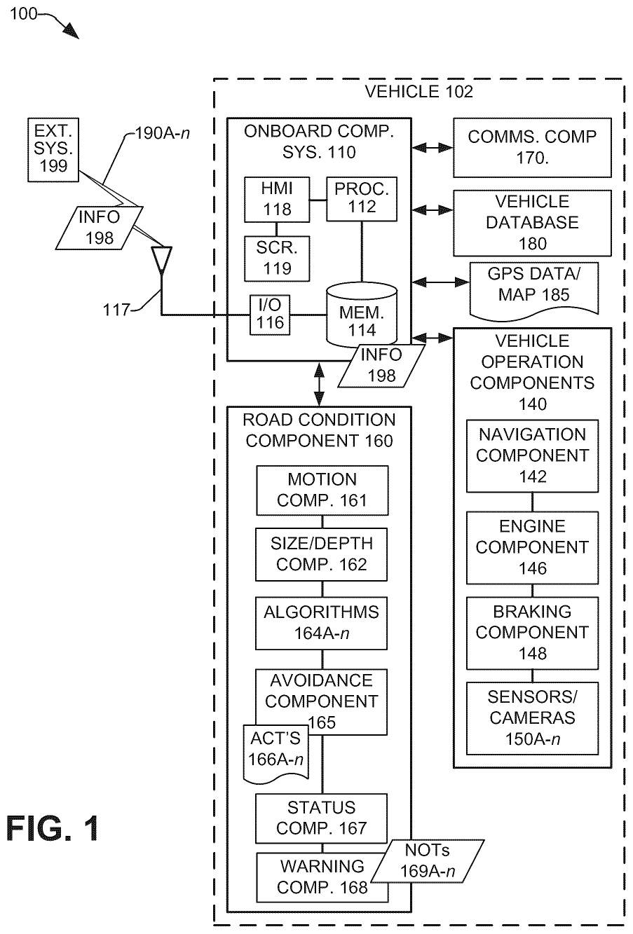

Turning now to the drawings, FIG. 1 illustrates a system 100 that can be utilized by an AV to detect and navigate a deleterious road condition, according to at least one embodiment. System 100 comprises a vehicle 102 with various devices and components located thereon, such as an onboard computer system (OCS) 110, wherein the OCS 110 can be a vehicle control unit (VCU). The OCS 110 can be utilized to provide overall operational control and/or operation of the EV. In an embodiment, the OCS 110 can be configured to operate/control/monitor various vehicle operations, wherein the various operations can be controlled by one or more vehicle operation components 140 communicatively coupled to the OCS 110. The various vehicle operations 140 can include a navigation component 142 configured to navigate vehicle 102 along a road as well as to control steering of the vehicle 102, wherein steering can form part of the DDT operational function, as previously described. The vehicle operation components 140 can further comprise an engine component 146 configured to control operation, e.g., start/stop, of an engine configured to propel the vehicle 102. The vehicle operation components 140 can further comprise a braking component 148 configured to slow down or stop the vehicle 102 (e.g., during avoidance of or navigation through a pothole). The braking component 148 can also be configured to control acceleration of the vehicle 102, wherein braking and acceleration of the vehicle 102 can form part of the DDT operational function, as previously described.

The vehicle operation components 140 can further comprise a plurality of sensors and/or cameras 150A-n configured to monitor operation of vehicle 102 and further obtain imagery and other information regarding an environment/surroundings the vehicle 102 is operating in. The sensors/cameras 150A-n can include any suitable detection/measuring device, including cameras, optical sensors, laser sensors, Light Detection and Ranging (LiDAR) sensors, sonar sensors, audiovisual sensors, perception sensors, road lane sensors, motion detectors, velocity sensors, and the like, as employed in such applications as simultaneous localization and mapping (SLAM), and other computer-based technologies and methods utilized to determine an environment being navigated by vehicle 102 and the location of the vehicle 102 within the environment (e.g., location mapping).

As shown, vehicle 102 can further comprise a road condition component 160 which further comprises various components that can be utilized to determine, in a non-limiting list, whether a deleterious road condition is about to be navigated by the vehicle 102, the magnitude of the deleterious road condition, how to avoid the deleterious road condition, a continued existence of a deleterious road condition, and suchlike. In an example embodiment, the road condition component 160 can be utilized as part of the tactical function/OEDR. A motion component 161 can be included in the road condition component 160, wherein the motion component 161 can be configured to determine motion of a vehicle driving ahead of vehicle 102, and based upon the determined motion, the motion component 161 can further determine an existence of one or more road conditions. A size/depth component 162 can be configured to determine a magnitude of the road condition, e.g., width/length of a pothole, road debris, speed ramp, etc.; a height of a speed bump; the depth of a recessed speed bump; depth of a pothole; and suchlike. In an embodiment, the size/depth component 162 can operate in conjunction with the motion component 161 such that information generated by the motion component 161 (e.g., via algorithms 164A-n regarding the motion of the lead vehicle) can be utilized by the size/depth component 162 to make an assessment regarding the road condition.

The road condition component 160 can further comprise various algorithms 164A-n respectively configured to determine presence of a road condition, the magnitude of the road condition, and suchlike.

The road condition component 160 can further include an avoidance component 165 configured to control and/or generate actions and/or recommendations (e.g., actions 166A-n) for control of operation of the vehicle 102 (e.g., switch to left lane to avoid pothole in road), wherein the avoidance component 165 can operate in conjunction with one or more of the vehicle operation components 140. The avoidance component 165 can be further configured to control operation of vehicle 102 based on information, data, etc., received from other vehicles navigating, or recently navigated, the road. In an embodiment, the avoidance component 165 can control operation of the vehicle 102 via instructing the any of vehicle operations components 140 (e.g., navigation component 142, engine component 146, braking component 148) and/or onboard computing system 110 to perform the actions 166A-n.

The road condition component 160 can further include a status component 167, wherein the status component 167 can be configured to monitor an existence of a pothole or other road condition to facilitate operation of the vehicle 102, file a report to a municipality, police force, etc., regarding a presence and/or continued presence of the pothole, etc.

In a further embodiment, the road condition component 160 can further include a warning component 168, wherein the warning component 168 can be configured to generate one or more notifications 169A-n regarding the existence of a road condition (e.g., road condition 250, as further described herein) and whether any adjustment is being performed by the vehicle 102 to navigate/avoid the road condition. In another embodiment, the one or more notifications 169A-n can be presented on a screen on a HMI (e.g., a screen 119 on HMI 118, as further described).

Vehicle 102 can further include a communications component 170 configured to establish and conduct communications with other vehicles on the road, external entities and systems, etc. The vehicle 102 can also include a vehicle database 180, wherein the vehicle database 180 can comprise various vehicle identifiers such as a makes/models, list of license plates and vehicles they are registered to, and suchlike, to enable determination of a vehicle operating in the locality of vehicle 102. The vehicle database 180 can further include information regarding a model/make of a vehicle, such as the axle width of the vehicle, such that the axle width of a lead vehicle can be determined from the license plate and/or the make/model of the lead vehicle as determined by analysis of imagery of the lead vehicle captured by the one or more cameras 150A-n and a computer vision algorithm(s) in algorithms 164A-n.

As shown in FIG. 1, the OCS 110 can further include a processor 112 and a memory 114, wherein the processor 112 can execute the various computer-executable components, functions, operations, etc., presented herein. The memory 114 can be utilized to store the various computer-executable components, functions, code, etc., as well as algorithms 164A-n, road condition information/data 198, information regarding a pothole location, pothole size, information received from a remotely located system/vehicle, extracted-data, edited-data, and suchlike (as further described herein). In an embodiment, the vehicle operation components 140 can form a standalone component communicatively coupled to the OCS 110, and while not shown, the vehicle operation components 140 can operate in conjunction with a processor (e.g., functionally comparable to processor 112) and a memory (e.g., functionally comparable to memory 114) to enable navigation, steering, braking/acceleration, etc., of vehicle 102 to a destination. In another embodiment, the vehicle operation components 140 can operate in conjunction with the processor 112 and memory 114 of the OCS 110, wherein the various control functions (e.g., navigation, steering, braking/acceleration) can be controlled by the OCS 110. Similarly, the road condition component 160 can form a standalone component communicatively coupled to the OCS 110, and while not shown, the road condition component 160 can operate in conjunction with a processor (e.g., functionally comparable to processor 112) and a memory (e.g., functionally comparable to memory 114) to enable navigation and object sensing/avoidance during operation of vehicle 102 to a destination. In another embodiment, the road condition component 160 can operate in conjunction with the processor 112 and memory 114 of the OCS 110, wherein the various object sensing/navigating/avoidance functions can be controlled by the OCS 110. In a further embodiment, the OCS 110, vehicle operation components 140, and the road condition component 160 (and respective sub-components) can operate using a common processor (e.g., processor 112) and memory (e.g., memory 114).

As further shown, the OCS 110 can include an input/output (I/O) component 116, wherein the I/O component 116 can be a transceiver configured to enable transmission/receipt of information (e.g., pothole existence data, road debris data, and the like) between the OCS 110 and any external system(s) (e.g., external system 199), e.g., other vehicles navigating the road, entities administering operation of the road (e.g., assigned to fill potholes, remove debris, etc.), police force, entities provisioning navigation data (e.g., GPS data), and the like. I/O component 116 can be communicatively coupled, via an antenna 117, to the remotely located devices and systems (e.g., external system 199). Transmission of data and information between the vehicle 102 (e.g., via antenna 117 and I/O component 116) and the remotely located devices and systems can be via the signals 190A-n. Any suitable technology can be utilized to enable the various embodiments presented herein, regarding transmission and receiving of signals 190A-n. Suitable technologies include BLUETOOT®, cellular technology (e.g., 3G, 4G, 5G), internet technology, ethernet technology, ultra-wideband (UWB), DECAWAVE®, IEEE 802.15.4a standard-based technology, Wi-Fi technology, Radio Frequency Identification (RFID), Near Field Communication (NFC) radio technology, and the like.

In an embodiment, the OCS 110 can further include a human-machine interface (HMI) 118 (e.g., a display, a graphical-user interface (GUI)) which can be configured to present various information including imagery of/information regarding potholes, road debris, road being driven, alarms, warnings, information received from external systems and devices, etc., per the various embodiments presented herein. The HMI 118 can include an interactive display 119 to present the various information (e.g., notifications 169A-n generated by warning component 168) via various screens presented thereon, and further configured to facilitate input of information/settings/etc., regarding operation of the vehicle 102.

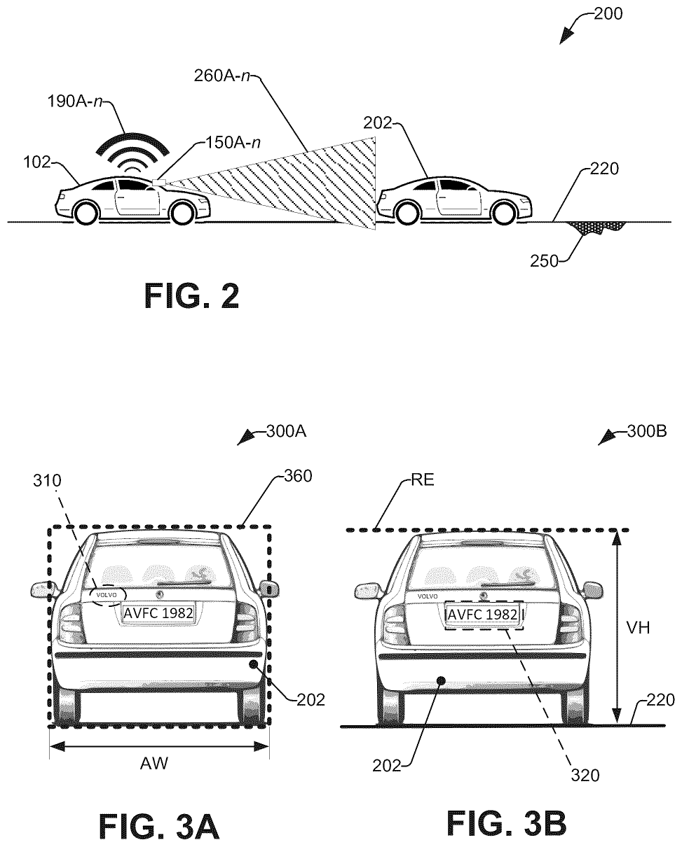

Turning to FIG. 2, schematic 200 illustrates vehicles approaching a road condition, according to an embodiment. As shown, the vehicle 102 is driving behind another vehicle 202, wherein the vehicle 202 can be an automobile, a truck, a motorbike, and the like. The vehicle 102 is driving such that the ability for the various onboard sensors/cameras 150A-n and algorithms 164A-n to detect/identify road conditions ahead is impeded by the presence of vehicle 202. For example, the field of view of camera 150A is obstructed by the vehicle 202 and, accordingly, a pothole 250 in road surface 220 is not readily detected (e.g., not in field of view 260A-n of sensors 150A-n) by the camera 150A and the one or more computer vision algorithms 164A-n configured to analyze images provided by camera 150A for potholes, road debris, etc. It is to be noted that the identifiers 260A-n are used herein interchangeably to denote both a field of view of a respective sensor 150A-n as well as to indicate data/imagery that is obtained by the respective sensors 150A-n from objects and features in the landscape being navigated by vehicle 102.

Turning to FIGS. 3A and 3B, schematics 300A and 300B present various embodiments to determine various dimensions of a lead vehicle, while driving behind the vehicle. One or more embodiments presented herein take advantage of how vehicle 202 operates as it navigates the road 220. In an embodiment, as shown in FIG. 3A, a camera 150A on vehicle 102 can capture imagery that includes a make/model identifier 310 of vehicle 202. A computer vision algorithm 164A on vehicle 102 can identify and extract the make/model identifier 310 from sensing data obtained from the field of view 260A-n of the respective sensors 150A-n. In another embodiment, as shown in FIG. 3B, a camera 150A on vehicle 102 can capture imagery that includes the license plate of vehicle 202, a computer vision algorithm 164A can identify and extract the license plate number 320 from sensing data obtained from the field of view 260A-n of the respective sensors 150A-n. The vehicle database 180 can then be reviewed (e.g., by the OCS 110), with the make/model 310 and/or license plate number 320 identified, from which the make/model 310 of the of vehicle 202 can be extracted along with various dimensions regarding the vehicle 202, e.g., axle width (AW), vehicle height (VH), and suchlike. These dimensions (e.g., AW, VH) can then be utilized to determine motion (e.g., by motion component 161 regarding vertical deflection/displacement of vehicle 202) and placement of vehicle 202 regarding the road surface 220 and various road conditions 250 (e.g., potholes, road debris, speed bumps, speed humps, traffic calming device, sleeping policeman, traffic threshold, speak breaker, speed cushion, speed table, etc.) that can affect a relationship of a vehicle dimension of vehicle 202 with the road surface 220. Further an upper edge of the vehicle 202 (reference line/edge (RE)) is effectively parallel (e.g., taking into account road camber, and suchlike) to the road surface 220. RE can be used to determine (e.g., by the motion component 161) an angle of alignment of the vehicle 202, e.g., as a function of driving through a pothole 250, as further described herein.

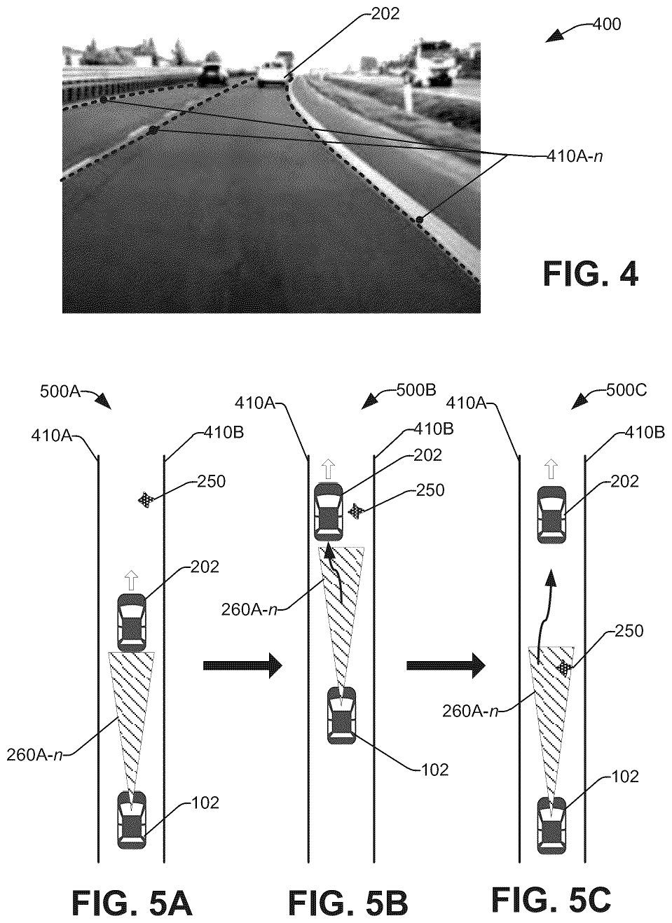

As well as monitoring the vehicle 202, the field of view 260A of the camera 150A and/or field of detection 260B of sensor 150B can also include any lane markings for the road being driving, e.g., white and/or yellow painted stripes indicating a road edge, road/pavement interface, slow lane, fast lane, bus lane, bike lane, pedestrian lane, etc., where the stripes can be a continuous line or a broken pattern. Lane markings can also be identified by other techniques, such as white stones, rumble strips, reflective beads or surfaces located on or in a road surface, such as reflective studs colloquially termed “cat's eyes”, and such like. FIG. 4, image 400, is an image generated from data generated by one or more sensors 150A-n (e.g., from camera 150A) of a road being navigated by various vehicles, with various lane markings 410A-n identified (e.g., by a computer vision algorithm 164A).

FIGS. 5A-5C, schematics 500A-C, illustrate an AV monitoring operation of a lead vehicle to determine a road condition ahead, in accordance with one or more embodiments presented herein. As shown in FIG. 5A, vehicle 102 is located and driving behind vehicle 202 between lane markers 410A and 410B, with vehicle 202 being the leading vehicle and vehicle 102 being the trailing vehicle. As vehicle 202 navigates the road, it approaches a pothole 250, however, as previously mentioned, owing to the presence/size of vehicle 202, the respective sensors 150A-n onboard vehicle 102 and their respective field of view 260A-n are unable to detect the presence of the pothole 250. In FIG. 5B, the vehicle 202 has observed the pothole 250 (e.g., the driver of vehicle 202 has seen the pothole 250, sensors onboard vehicle 102 detected the pothole 250, and suchlike), and has corrected its path to maneuver around the pothole 250. Motion component 161 can detect a change in position of vehicle 202 (e.g., with regard to vehicle 102′s position and/or vehicle 202′s position with respect to the lane markings 410A and 410B), for example, via sensors 150A-n onboard vehicle 102 along with the algorithms 164A-n, and vehicle 102 can determine whether it is to perform a similar maneuver (e.g., via avoidance component 165).

In an embodiment, prior to vehicle 102 performing the similar maneuver to that performed by vehicle 202, the sensors 150A-n onboard vehicle 102 can determine that the portion of road 220 that vehicle 202 appeared to maneuver around does not contain a pothole, and accordingly vehicle 102 can navigate without executing the maneuver, as the vehicle 102 has made a determination that vehicle 202 was maneuvered for a reason that had nothing to do with the potential presence of a pothole in the road, e.g., the driver of vehicle 202 wasn't paying attention to the road (e.g., was on cellphone, distracted by a passenger, distracted by a advertising billboard, is driving under the influence of drugs/alcohol, is driving visually impaired, and the like) and vehicle 202 simply made a maneuver to correct the trajectory of the vehicle 202.

At FIG. 5C, the vehicle 102 can make various maneuvers/trajectory corrections based upon how vehicle 202 was operated when navigating the pothole 250. For example, as previously mentioned, vehicle 102 may know the make/model of vehicle 202 and the axle width AW of vehicle 202. In the event that the AW of vehicle 102 is comparable to vehicle 202, and the vehicle 202 was able to navigate around and/or over the pothole 250 without one or more of vehicle 202′s tires going into the pothole (or not to any appreciable effect on the vehicle 202′s alignment), vehicle 102 can select (e.g., by avoidance component 165) to follow the route taken by vehicle 202.

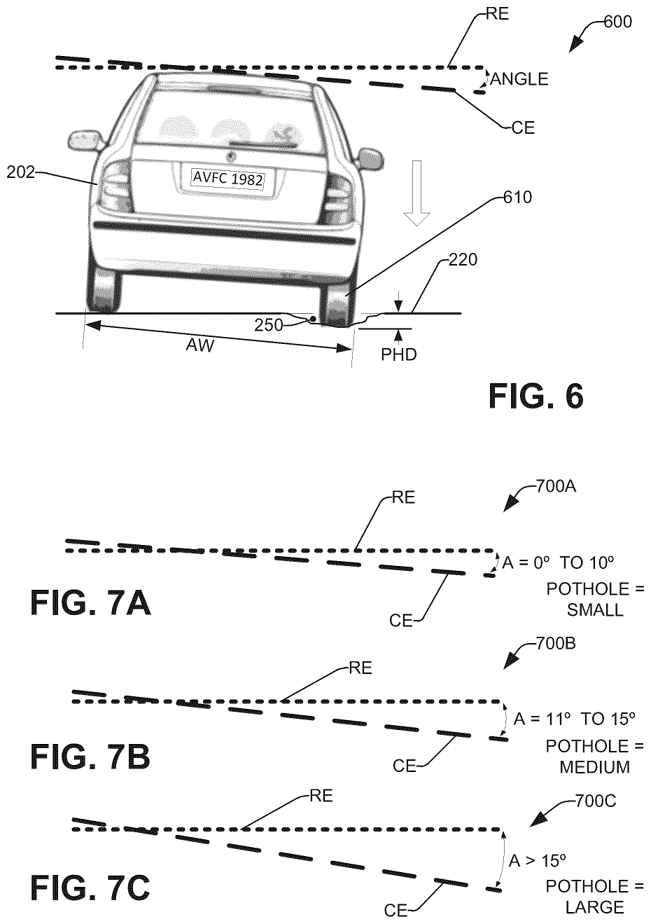

However, rather than being able to navigate around the pothole 250, vehicle 202 may encounter the pothole, e.g., one or more of the tires 610 on vehicle 202 enter the pothole 250. Turning to FIG. 6 presents a schematic 600 of vehicle 202′s alignment relative to the road surface 220, in accordance with one or more embodiments. FIG. 6 illustrates the vehicle 202 has encountered/is navigating, a pothole 250, e.g., at least one of the tires 610 (e.g., tires on a passenger-side, right side as viewed from rear) on the vehicle 202 is placed in the pothole 250. As shown, the current upper edge (CE) is no longer parallel to the road surface 220, or parallel/coincident with edge RE, rather, edge CE is angled to the edge RE. The difference in angle between RE and CE can assist in determining the depth PHD of pothole 250. Further, the axle width AW of vehicle 202 can also be a factor in the angle of the edge CE relative to the edge RE, which can be further utilized to determine the depth of the pothole 250. For example, for a vehicle having a narrow AW, a first angle between CE to RE is likely to be larger than a second angle between CE to RE for a vehicle having a wider AW. Algorithms 164A-n can be utilized to determine pothole depth PHD, with algorithms 164A-n being configured to utilize one or more of the angle of RE, the angle of CE, height VH of vehicle 202, axle width AW of vehicle 202, etc. Accordingly, based upon the change in respective angles, the motion component 161 and/or the size/depth component 162 can determine the relative motion and/or change in displacement of the vehicle 202 relative to the road 220.

Turning to FIGS. 7A-7C, schematics 700A-C illustrate utilizing an alignment of a vehicle relative to a road surface to determine a depth of a pothole, in accordance with one or more embodiments. As shown in FIGS. 7A-C, the angle of the edge CE relative to the edge RE can be an indicator of a depth of the pothole 250. For example, as shown in FIG. 7A, a small angle (e.g., 0° to 10°) between RE and CE can enable categorization (e.g., by the motion component 161 in conjunction with the size/depth component 162) of the pothole as being “small” or “shallow” in depth. As shown in FIG. 7B, a moderate angle (e.g., 11° to 15°) between RE and CE can enable categorization of the pothole as being “medium” in depth. As shown in FIG. 7C, a large angle (e.g., >15°) between RE and CE can enable categorization of the pothole as being a “large”, “big”, or “deep” pothole. Based on how the pothole 250 has been categorized, e.g., small, medium, large, vehicle 102 can perform one or more maneuvers/driving actions (e.g., avoidance component 165 initiating one or more actions 166A-n) based upon the depth of pothole 250. It is to be appreciated that the angles and grading provided in the examples presented in FIGS. 7A-C are arbitrary and any magnitude scaling system can be utilized (e.g., taking into account axle width AW). For example, and in a non-limiting list, vehicle 102 can determine (e.g., via road condition component 160 and vehicle operations components 140) the following actions (e.g., in actions 166A-n) can be configured:
a) small pothole 250=an action 166A can be enacted (e.g., by avoidance component 165) where vehicle 102 can slow down (e.g., via a combination of engine component 146 operating with braking system 148) and attempt to avoid the pothole while driving in the same lane as the pothole 250 is located in.
b) medium pothole 250=an action 166B can be enacted (e.g., by avoidance component 165) where vehicle 102 can brake (e.g., via the braking system 148) to avoid the pothole 250 while driving in the same lane as the pothole 250 is located in.
c) large pothole 25 =an action 166C can be enacted (e.g., by avoidance component 165) where vehicle 102 can perform any of (i) brake (e.g., via the braking system 148), (ii) operate hazard lights (e.g., as controlled by the OCS 110), and/or in the event of a determination is made (e.g., by the avoidance component 165) that avoiding the pothole 250 is not possible while remaining in the same lane as which the pothole 250 is located, vehicle 102 can be steered into the adjacent lane (e.g., by navigation component 142), if possible (e.g., an adjacent lane exists, the adjacent lane is clear, it is safe to switch lanes, etc.).

It is to be appreciated that while the respective positions of CE relative to RE are determined to be below the RE, the position of CE relative to RE can also be above the RE. For example, the tires on one side of the AV 102 drive over road debris while the tires on the other side do not. Accordingly, the position of CE could go higher than the RE, with the measured angle giving an indication of the height of the road debris in a converse but corresponding manner to how the relative angle between CE and RE indicated a depth of a pothole 250.

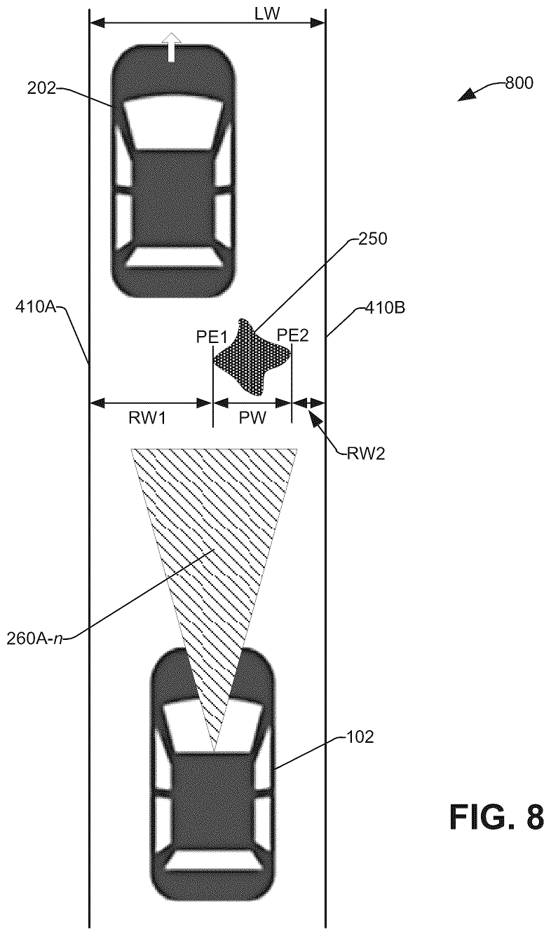

As mentioned, once the vehicle 202 has any of passed by, navigated around, gone over/through the pothole 250, vehicle 202 no longer obscures the pothole 250 from the various sensors 150A-n onboard vehicle 102, and the various pothole detecting systems and algorithms 164A-n onboard vehicle 102 can determine a size of the pothole 250. Various image processing techniques can be utilized (e.g., based on images generated by a camera 150C) to assess the size of the pothole 250 and whether the pothole 250 can be avoided by vehicle 102. Turning to FIG. 8, schematic 800, illustrates a vehicle determining a size of a pothole 250 (e.g., relative to a width of a lane LW), where the pothole 250 is not obscured by a leading vehicle 202, in accordance with an embodiment. For example, a first distance, road width RW1 can be determined (e.g., by size/depth component 162 and/or avoidance component 165) between a first edge PE1 of the pothole 250 and a first lane marking 410A and a second distance RW2 can be determined between a second edge PE2 of the pothole 250 and a second lane marking 410B. By knowing the distance between the lane marking 410A and the lane marking 410B, e.g., the width LW of the lane, the width PW of the pothole 250 can be determined (e.g., by size/depth component 162) based upon LW−(RW1+RW2)=PW.

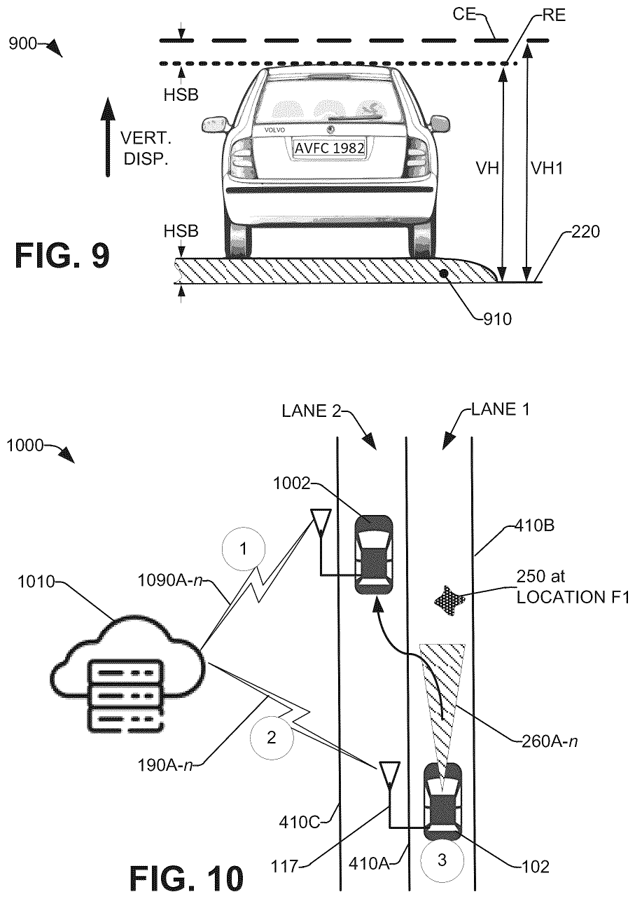

Turning to FIG. 9, schematic 900, illustrates a vehicle 202 navigating a speed bump or other structure (e.g., road debris laying in the road) that causes the position of vehicle 202 to be elevated relative to the road surface 220, in accordance with an embodiment. As shown the position CE is elevated compared to the height of PE owing to a function of the height HSB of the speed bump 910 causing the roof of vehicle 202 to be raised as the vehicle 202 traverses the speed bump 910. Owing to the difference in height between the PE and CE (e.g., as a function of the HSB of speed bump 910), a determination (e.g., by size/depth component 162 and/or motion component 161) can be made that the road surface 220 has a speed bump 910 incorporated into/located on it. During operation of the vehicle 202, the driver may not see the speed bump, drives over it without braking, and accordingly, there is no visual indication (e.g., no brake lights being illuminated) that vehicle 202 traversed the speed bump 910. In an embodiment, the location of the speed bump 910 can be further confirmed by referencing navigation data (e.g., GPS data/map 185) available to the vehicle 102 that indicates a speed bump 910 is located in the road 220 about to be traversed by the vehicle 102. While speed bumps 910 are conventionally an upwardly protruding structure compared to the height of the road surface 220, speed bumps can also be constructed/configured as a recess into the road surface such that a vehicle's tires “drop” into the speed bump as the speed bump is being traversed with an according drop in the height of CE relative to PE. Accordingly, the vehicle 102 can navigate the recessed speed bump in a similar manner to how the vehicle 102 navigates a raised speed bump 910.

In a further embodiment, the information 198 acquired by vehicle 102 as it navigates various road conditions, e.g., encounters potholes 250, speed bumps 910, road debris, and suchlike, can be stored on vehicle 102, e.g., in memory 114, used to supplement GPS/data map 185, and such like. To aid operation of other vehicles on the road, the information 198 can be shared by various vehicles (e.g., vehicles 102, 202, other vehicles) with other vehicles, wherein such sharing of information can utilize technologies involving sharing the information 198 to a “cloud-based” system as well as directly between vehicles (e.g., using local communication technology). FIG. 10, schematic 1000 illustrates such an information sharing operation being performed, in accordance with one or more embodiments. As shown, a vehicle 1002 approaches the pothole 250, and to maneuver around it, switches lane from a first lane, LANE 1 (between lines 410A and 410B), to a second lane, LANE 2 (between lines 410A and 410C). Both vehicles 1002 and 102 can be configured to interact and share information with a cloud-based system 1010 (e.g., external system 199 comprising a remotely located information sharing system/server, and suchlike), for example, vehicle 102 is an AV, while vehicle 1002 is also an AV, or vehicle 1002 is human-operated (e.g., in non-AV mode) but is configured to forward road condition information to the cloud-based system 1010. At (1), vehicle 1002 can transmit a signal 1090A-n to the cloud-based system 1010 indicating that a sizeable pothole 250 exists in LANE 1 at a location F1. At (2) vehicle 102 can receive a signal 190A-n from the cloud-based system 1010 indicating that there is a pothole 250 located ahead in LANE 1 and that vehicle 1002 had maneuvered into LANE 2 to avoid the pothole 250. At (3), based on the received information in signal 190A-n, vehicle 102 can make a determination (e.g., in actions 166A-n) on how to navigate the pothole 250, wherein the navigation operation can involve vehicle 102 moving into LANE 2 to avoid pothole 250, e.g., if it is safe to do so. In a further embodiment, the information 198 acquired by vehicle 102 can be shared with one or more entities assigned to assess/repair/remove potholes 250, road debris, etc. Such entities can be a local police force/highway patrol tasked with keeping the roads clear, also a department of road/highway maintenance, and suchlike who are tasked to keep the roads clear as well as repair a road surface 220 as/when potholes 250 and such like begin to form/appear. In an embodiment, the vehicle 102 can communicate directly (e.g., in signals 190A-n) with any of the local police force/highway patrol/road maintenance/highway maintenance (e.g., based upon information available to the vehicle 102 regarding communications to such entities). In another embodiment, the cloud-based system 1010 can be configured to forward the information 198 received from the vehicle 102 to the respective entity.

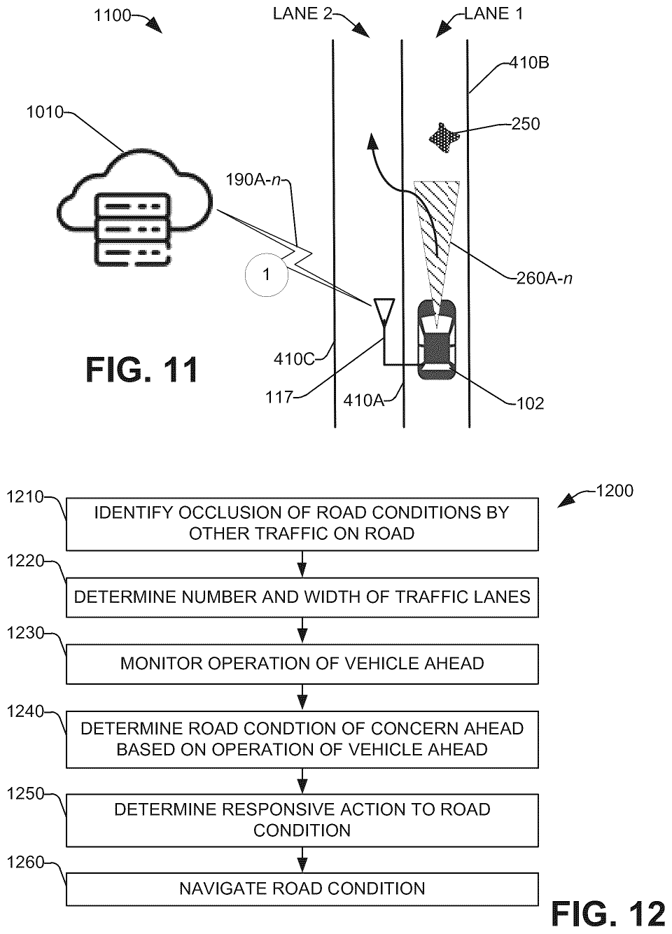

In another aspect, a pothole 250 may be in existence for a number of days/weeks/months. FIG. 11, schematic 1100 illustrates a vehicle monitoring an existence/removal of a pothole over a course of time, in accord with an embodiment. With FIG. 11, in an event of the vehicle 102 navigates the road on multiple occasions, the vehicle 102 can update information 198 regarding the current status of a pothole 250 and/or when a pothole no longer exists (e.g., it has been fixed). As shown in FIG. 11, vehicle 102 can continue to update information 198 provided to the cloud-based system 1010, regarding the size of the pothole 250, e.g., owing to vehicles hitting the pothole, weather conditions, etc., the size of the pothole 250 is increasing from small→medium→large. And furthermore, in the event that the pothole 250 is fixed (e.g., filled in), the vehicle 102 can send an updated information 198 to the cloud-based system 1010 that the pothole 250 has been fixed. The cloud-based system 1010 can be configured to forward the information 198 and any updates made to it to other vehicles (e.g., other vehicles, e.g., vehicles 202, 1002, in communication with the cloud-based system 1010, such as drivers of non-AV that want to be informed of various road conditions, as well as AV systems such as those operating on vehicle 102, e.g., via OCS 110, road condition component 160, and suchlike).

FIG. 12 illustrates a flow diagram 1200 for a computer-implemented methodology for controlling navigation of a road condition in a circumstance where view of the road condition by onboard sensors is obstructed, in accordance with at least one embodiment.

At 1210, an AV (e.g., AV 102) can determine that a view of a road 220 about to be navigated is obscured by other traffic (e.g., by lead vehicle 202), weather conditions (e.g., snow, rain, and suchlike), and the like, and the AV cannot exclusively rely on data (e.g., digital imagery) generated by various sensors (e.g., sensors 150A-n and sensing information 260A-n) onboard the AV.

At 1220, the AV can gather information about the road being navigated (e.g., via sensors 150A-n and sensing information 260A-n), including the number of lanes (e.g., LANE 1, LANE 2, lane markings 410A, 410B, 410C, etc.) available on the road, e.g., in the event that the AV may have to switch from a first lane to a second lane to avoid a road condition (e.g., a pothole 250, road debris, etc.).

At 1230, to supplement information being acquired by the various onboard sensors regarding the road surface conditions, one or more sensors (e.g., sensors 150A-n) can be configured to capture imagery/information (e.g., sensor data 260A-n) of a lead vehicle (e.g., vehicle 202, vehicle 1002) being driven ahead of the AV. Operation of the lead vehicle can be monitored (e.g., by motion component 161) with regard to an alignment of a structure on the lead vehicle (e.g., the roof) relative to the road surface, a change in vertical displacement of a structure on the lead vehicle (e.g., the roof) relative to the road surface, a maneuver by the lead vehicle to avoid a road condition, a license plate of the lead vehicle, a make/model marking(s) on the lead vehicle, and the like.

At 1240, part of the monitoring operation (e.g., by motion component 161) can include processing the imagery/information (e.g., sensor data 260A-n) to extract information (e.g., data 198) which can be utilized by various onboard computer operations/processes (e.g., algorithms 164A-n) to generate determinations regarding the operation of the lead vehicle and what may be causing the lead vehicle to be operated in such a manner (e.g., a pothole in the road, distracted driving, and the like).

At 1250, based upon the various determinations derived by the various onboard computer operations/processes (e.g., by motion component 161), the road condition can be identified, and one or more responsive actions (e.g., in actions 166A-n) can be generated (e.g., by avoidance component 165) to enable the AV to navigate the road condition (e.g., stay in lane but go around the pothole, switch to another lane to avoid the pothole, slow down to minimize the impact of driving through the pothole, slow down to traverse a speed bump, and suchlike).

At 1260, based upon the road condition determined to exist, and the various responsive actions generated based thereon, a responsive action can be selected to navigate the road condition (e.g., steer around the pothole). For example, a responsive action may be to switch lanes to navigate around the pothole, but there may be traffic in the adjacent lane (as determined by an onboard sensor configured to capture data regarding conditions in an adjacent lane (e.g., any of sensors 150A-n), and hence this action is unavailable. Accordingly, furthering the example, the AV has to traverse the pothole, but to limit potential damage to the AV, an action is generated to reduce the velocity of the AV (e.g., by braking component 148) such that the AV slows down prior to the tire(s) of the AV encounters the pothole.

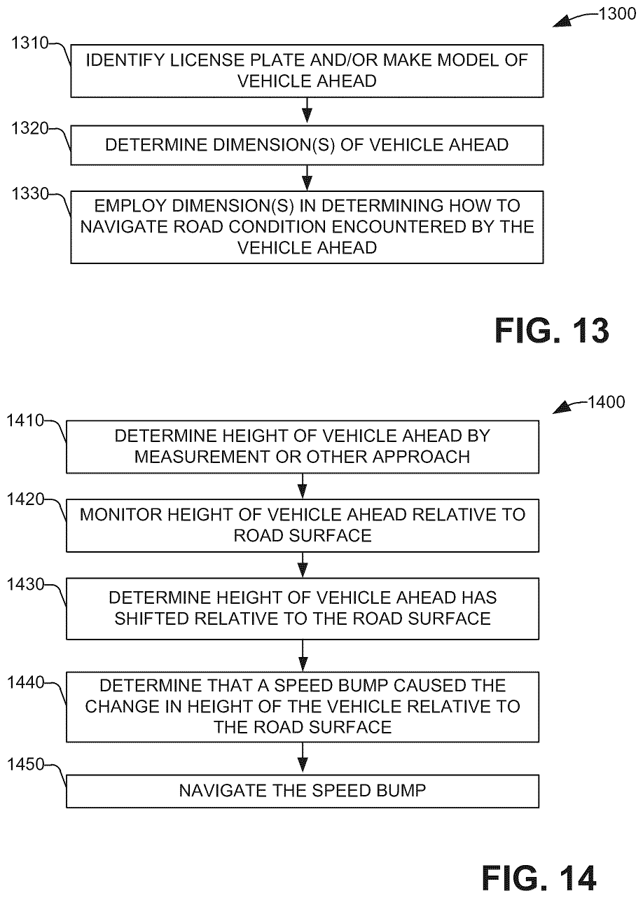

FIG. 13 illustrates a flow diagram 1300 for a computer-implemented methodology for determining dimensions of a vehicle based upon license plate and/or make/model of the vehicle, in accordance with at least one embodiment.

At 1310, imagery and suchlike (e.g., obtained by onboard sensors 150A-n) can be analyzed (e.g., by road condition component 160 using a digital imagery algorithm in algorithms 164A-n) to identify a vehicle (e.g., vehicle 202, 1002) being driven ahead of an AV (e.g., vehicle 102). In an embodiment, the license plate (e.g., license plate 320) of the vehicle ahead can be read and the make/model of the vehicle determined (e.g., from an onboard vehicle database 180 comprising license plates, manufacturers, vehicle models, and other vehicle data). In another embodiment, a vehicle identifier (e.g., manufacturer badge/model 310) can be identified.

At 1320, based on knowing the make/model of the vehicle ahead, the database (e.g., database 180) can be further reviewed to obtain the respective dimensions, etc., of the vehicle ahead, such as the axle width (e.g., AW), a roof height (e.g., VH) or height of other structure on the vehicle, and the like.

At 1330, the various dimensions determined regarding the vehicle ahead can be utilized to determine how to navigate the road condition based upon how the vehicle ahead navigated the road condition (e.g., by avoidance component 165). For example, is the AV of a similar width to the lead vehicle such that if the lead vehicle was able to drive around the pothole without having to switch lanes, can the AV perform a similar maneuver? The various dimensions determined for the lead vehicle can be utilized per the various example methods presented herein.

FIG. 14 illustrates a flow diagram 1400 for a computer-implemented methodology for determining presence of a speed bump based on vertical displacement of a lead vehicle, in accordance with at least one embodiment.

At 1410, as mentioned, the height (VH) of the lead vehicle can be determined (per FIG. 13) by utilizing various markings (e.g., license plate and/or make/model) identified (e.g., by motion component t161) on the lead vehicle (e.g., vehicle 202). In another embodiment, the height of the vehicle ahead can be determined by measuring the height of the vehicle relative to the road surface (e.g., while taking into account distance between the lead vehicle and the AV), wherein the height can be measured based upon analyzing data (e.g., by motion component 161 applying algorithms 164A-n to digital images in sensor data 260A-n) captured from the vehicle ahead.

At 1420, as the AV is driving behind the lead vehicle (e.g., vehicle 202), the height (VH) of the lead vehicle relative to the road surface (e.g., road 220) can be continuously monitored (e.g., by motion component 161 utilizing the onboard sensors 150A-n, data 260A-n, algorithms 164A-n, and the like). Hence, when a flat road is being navigated the height of the lead vehicle should remain relatively consistent relative to the road surface owing to the lack of undulations in the road surface.

At 1430, a determination can be made (e.g., by the motion component 161, road condition component 160 and associated components) that the height of the lead vehicle has shifted relative to the road surface. In an example, the height of the vehicle may have undergone a positive vertical displacement such that the newly measured distance between the roof of the vehicle and the road surface exceeds height VH. For example, while navigating a structure in the road, the vertical displacement of the lead vehicle relative to the road surface changes from height VH to VH1, as the AV is still driving on the regular road surface, such that the regular road surface can function as a reference point to the height of the lead vehicle, e.g., the height of CE (per FIG. 9).

At 1440, based upon the height of the roof (or other suitable reference point) of the lead vehicle shifting from a height of VH to VH1, it is possible to extrapolate (e.g., by the size/depth component 162) the height of the road condition causing the change in vertical displacement of the lead vehicle to the height of the road, such that: (height VH1−height VH)=height of the road condition, which in the example presented in FIG. 9, (height VH1−height VH)=height of speed bump HSB.

At 1450, based upon the knowledge that the AV is driving towards a speed bump (e.g., speed bump 910) or other structure causing a vertical shift in VH (e.g., a mattress that has fallen off of a truck), and the knowledge of the height of the speed bump HSB, the AV can make a determination (e.g., by avoidance component 165 and actions 166A-n) of how to navigate the speed bump. For example, in response to identifying the speed bump, the AV can slow down (e.g., using braking component 148) to traverse the speed bump in a manner that does not unduly cause shock to the AV, its occupant(s), cargo, and suchlike.

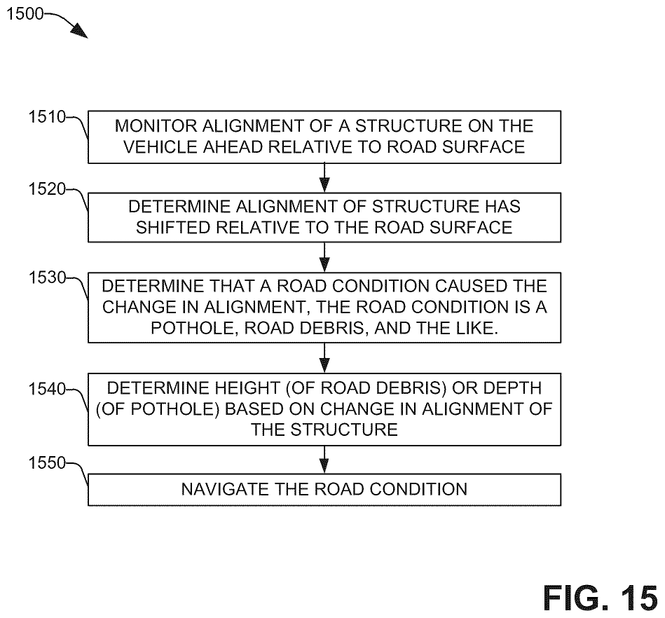

FIG. 15 illustrates a flow diagram 1500 for a computer-implemented methodology for determining presence of pothole based on change in alignment of a lead vehicle relative to a road surface, in accordance with at least one embodiment.

At 1510, an alignment of a structure on a lead vehicle (e.g., vehicle 202) travelling ahead of an AV (e.g., AV 102) can be monitored (e.g., by motion component 161) relative to a surface of a road (e.g., road 220). In an embodiment (per FIGS. 3A and 3B, 6, 7A-C), the structure can be the roof of the lead vehicle (as defined by 360 or reference edge RE) can be utilized. As shown, the alignment of RE can be determined.

At 1520, while the AV is driving behind the lead vehicle, a determination (e.g., by motion component 161) can be made that the alignment of RE can be determined to have shifted, e.g., to become the current edge CE.

At 1530, a determination (e.g., by motion component 161) can be made that a road condition (e.g., a pothole, road debris, partially navigating a speed bump (e.g., with tires 610 on one side of the vehicle and not the other)) caused the change in angle from RE to CE.

At 1540, a determination (e.g., by size/depth component 162) can be made regarding a magnitude of the road condition (e.g., depth of pothole 250, height of road debris/speed bump 910) based on the change in angle between RE and CE. With reference to FIGS. 7A-7C, in the examples presented, the greater the change in angle between RE and CE, the greater the depth or height of the road condition.

At 1550, based on the height or depth of the road condition, the AV can navigate the road condition/road based upon the various actions (e.g., by avoidance component 165 utilizing actions 166A-n) configured for operation of the AV when encountering a road condition.

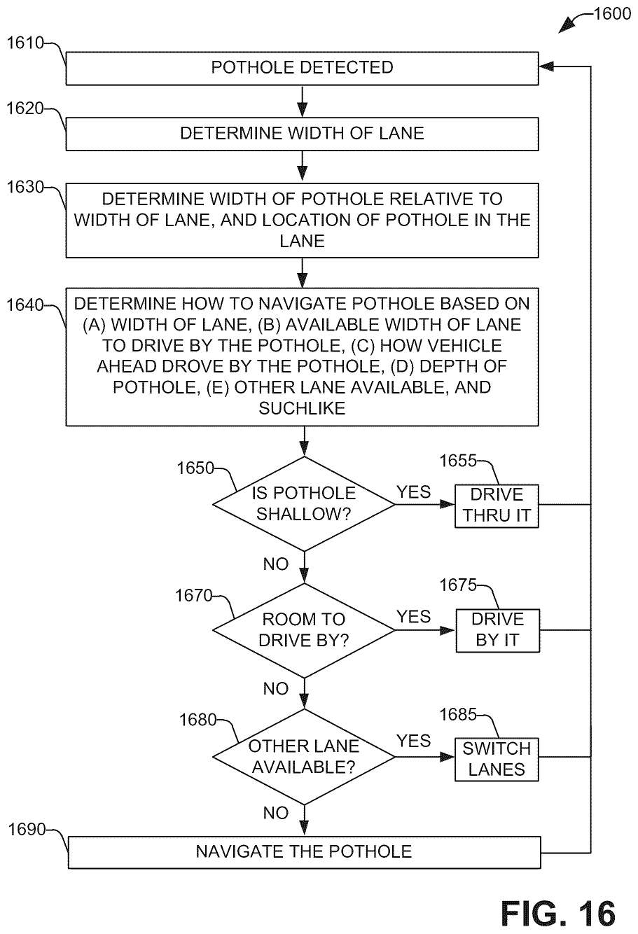

FIG. 16 illustrates a flow diagram 1600 for a computer-implemented methodology for determining whether to navigate a pothole, in accordance with at least one embodiment.

At 1610, a pothole 250 can be detected in a road surface 220. In an embodiment, the pothole can be detected (e.g., by motion component 161) as a function of motion of a lead vehicle (e.g., vehicle 202) ahead of an AV (e.g., vehicle 102), e.g., regarding alignment of the lead vehicle, height displacement of the lead vehicle, and suchlike, per one or more embodiments presented herein. In an embodiment, once the lead vehicle has maneuvered to enable detection of the pothole using sensors (e.g., sensors 150A-n) onboard the AV, the AV can make determinations (e.g., by size/depth component 162) regarding pothole, the road surface, etc.

At 1620, a lane width (e.g., FIG. 8, LW) of the road can be determined (e.g., by size/depth component 162), e.g., by measuring the difference between two set of lane markings (e.g., a first lane marking 410A and a second lane marking 410B).

At 1630, the width and location of the pothole can be determined (e.g., by size/depth component 162). For example, and as described with reference to FIG. 8, width of the pothole PW can be determined based upon: LW−(RW1+RW2)=PW.

At 1640, one or more determinations (e.g., by avoidance component 165) can be generated regarding how to navigate the pothole based on any of, in a non-limiting list: (a) lane width LW, (b) available width (e.g., RW1, RW2) of lane to drive by the pothole, (c) how did the lead vehicle (e.g., 202, 1002) navigate the pothole, (d) depth of the pothole, (e) adjacent lane available?, and the like. There follows an example sequence of operations, stepping through some of the examples (and possible actions 166A-n):

At 1650, a determination (e.g., by size/depth component 162) can be made regarding the depth of the pothole, e.g., is the depth of the pothole shallow and impact with the pothole would have negligible effect on the AV, its occupants, cargo, etc.?, is the depth of the pothole deep and impact with the pothole at speed could damage the AV, cargo, etc.? In response to determining that YES the pothole is shallow, methodology 1600 can advance to 1655 where an action (e.g., action 166F) is generated (e.g., by avoidance component 165) instructing the AV (e.g., navigation system 142) to drive through the pothole. The methodology 1600 can return to 1610 for the next pothole to be detected.

In response to a determination (e.g., by size/depth component 162) that NO the pothole is not shallow, methodology 1600 can advance to 1670, where a determination (e.g., by avoidance component 165) can be made regarding whether there is enough room in the lane (e.g., LANE 1) to drive by the pothole (given it is not shallow, as determined at 1650). In response to determining that YES there is enough room to navigate around the pothole, methodology 1600 can advance to 1675 where an action (e.g., action 166G) is generated instructing the AV (e.g., navigation system 142) to drive by the pothole while remaining in the current lane. The methodology 1600 can return to 1610 for the next pothole to be detected.

In response to a determination (e.g., by avoidance component 165) that NO there is not enough room to drive by the pothole while in the current lane, methodology 1600 can advance to 1680, where a determination (e.g., by avoidance component 165) can be made regarding whether there is an adjacent lane to navigate and is it safe to transfer to the adjacent lane (e.g., LANE 2) to drive by the pothole? In response to determining that YES there is another lane and it is safe to switch lanes, methodology 1600 can advance to 1685 where an action (e.g., action 166H) is generated instructing the AV (e.g., navigation system 142) to switch lanes and drive around the pothole. The methodology 1600 can return to 1610 for the next pothole to be detected.

In response to a determination (e.g., by avoidance component 165) that NO it is not possible or safe to switch to an adjacent lane, methodology 1600 can advance to 1690, where an action (e.g., action 166J) is generated instructing the AV (e.g., navigation system 142) to navigate (drive through) the pothole. In an embodiment, the action (e.g., action 166J) can include instructing the AV to reduce speed (e.g., via the braking component 148, reduce power via the engine component 146), or similar action to reduce the effect of the AV impacting the pothole. The methodology 1600 can return to 1610 for the next pothole to be detected.

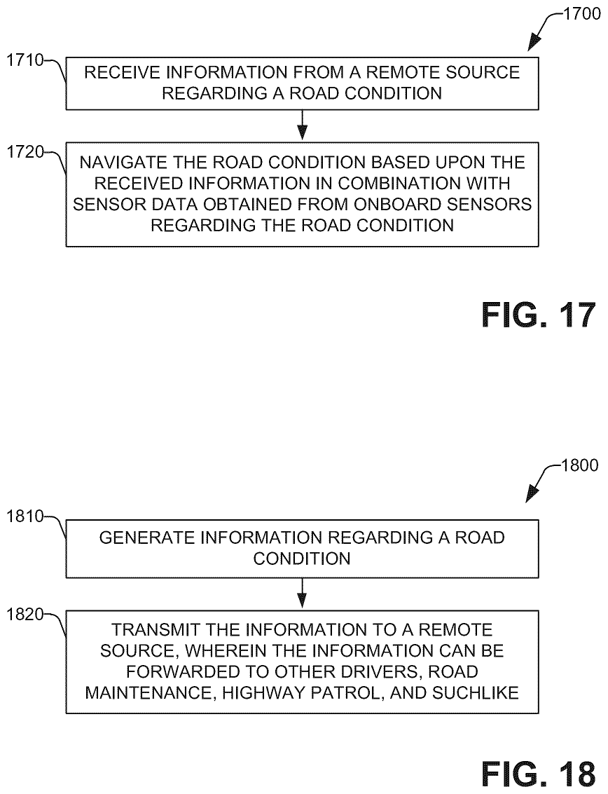

FIG. 17 illustrates a flow diagram 1700 for a computer-implemented methodology for receiving information regarding a road condition to be navigated, in accordance with at least one embodiment.

At 1710, information (e.g., information 198) can be received at an AV (e.g., vehicle 102) regarding a pothole (e.g., pothole 250) in a road 220 that the AV is driving along. The information can be received (e.g., from external system 199 via I/O component 116 and/or comms. component 170) directly from a vehicle (e.g., vehicle 1002) that has recently driven over or around the pothole, or the information can be received from a remotely located system such as a cloud-based computing system (e.g., cloud-based computing system 1010). The information can include data regarding the pothole size, pothole depth, pothole location, road width in the vicinity of the pothole, is it possible to drive around the pothole but stay in the lane, a lane shift is required, etc.

At 1720, based upon the received information as well as any information acquired and/or determined by the AV (e.g., via sensors 150A-n, algorithms 164A-n, motion component 161, size/depth component 162, and suchlike) the road condition can be navigated (e.g., by avoidance component 165), per the various embodiments presented herein.

FIG. 18 illustrates a flow diagram 1800 for a computer-implemented methodology for generating and transmitting information regarding a road condition, in accordance with at least one embodiment.

At 1810, during operation of an AV (e.g., vehicle 102) on a road (e.g., road 220) the AV can acquire a plethora of information (e.g., information 198) via various onboard sensors (e.g., sensors 150A-n) regarding the existence of one or more potholes. To aid others, the information can be shared by the AV to other drivers, other AVs, local police force/highway patrol tasked with keeping the roads clear, department of road/highway maintenance, and suchlike who have an interest in the condition of a road and/or road surface.

At 1820, the information can be transmitted (e.g., via I/O 116 and antenna 117) to a remotely located system (e.g., a cloud-based computing system 1010) or directly to a vehicle (e.g., vehicle 202, 1002).

### EXAMPLE APPLICATIONS AND USE

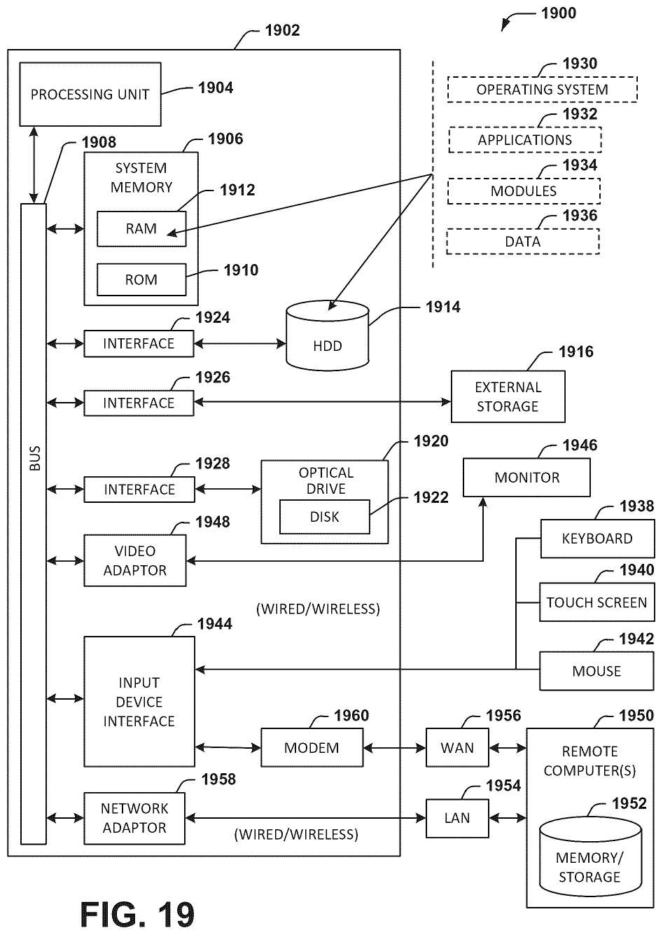

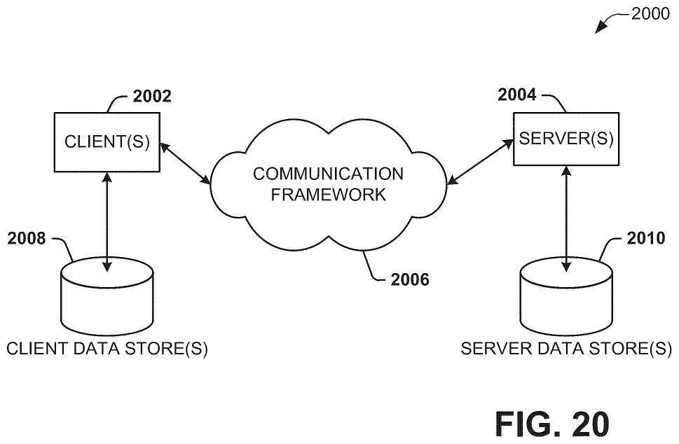

Turning next to FIGS. 19 and 20, a detailed description is provided of additional context for the one or more embodiments described herein with FIGS. 1-18.

In order to provide additional context for various embodiments described herein, FIG. 19 and the following discussion are intended to provide a brief, general description of a suitable computing environment 1900 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The embodiments illustrated herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 19, the example environment 1900 for implementing various embodiments of the aspects described herein includes a computer 1902, the computer 1902 including a processing unit 1904, a system memory 1906 and a system bus 1908. The system bus 1908 couples system components including, but not limited to, the system memory 1906 to the processing unit 1904. The processing unit 1904 can be any of various commercially available processors and may include a cache memory. Dual microprocessors and other multi-processor architectures can also be employed as the processing unit 1904.

The system bus 1908 can be any of several types of bus structure that can further interconnect to a memory bus (with or without a memory controller), a peripheral bus, and a local bus using any of a variety of commercially available bus architectures. The system memory 1906 includes ROM 1910 and RAM 1912. A basic input/output system (BIOS) can be stored in a non-volatile memory such as ROM, erasable programmable read only memory (EPROM),

EEPROM, which BIOS contains the basic routines that help to transfer information between elements within the computer 1902, such as during startup. The RAM 1912 can also include a high-speed RAM such as static RAM for caching data.

The computer 1902 further includes an internal hard disk drive (HDD) 1914 (e.g., EIDE, SATA), one or more external storage devices 1916 (e.g., a magnetic floppy disk drive (FDD) 1916, a memory stick or flash drive reader, a memory card reader, etc.) and an optical disk drive 1920 (e.g., which can read or write from a CD-ROM disc, a DVD, a BD, etc.). While the internal HDD 1914 is illustrated as located within the computer 1902, the internal HDD 1914 can also be configured for external use in a suitable chassis (not shown). Additionally, while not shown in environment 1900, a solid-state drive (SSD) could be used in addition to, or in place of, an HDD 1914. The HDD 1914, external storage device(s) 1916 and optical disk drive 1920 can be connected to the system bus 1908 by an HDD interface 1924, an external storage interface 1926 and an optical drive interface 1928, respectively. The interface 1924 for external drive implementations can include at least one or both of Universal Serial Bus (USB) and Institute of Electrical and Electronics Engineers (IEEE) interface technologies. Other external drive connection technologies are within contemplation of the embodiments described herein.

The drives and their associated computer-readable storage media provide nonvolatile storage of data, data structures, computer-executable instructions, and so forth. For the computer 1902, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1912, including an operating system 1930, one or more application programs 1932, other program modules 1934 and program data 1936. All or portions of the operating system, applications, modules, and/or data can also be cached in the RAM 1912. The systems and methods described herein can be implemented utilizing various commercially available operating systems or combinations of operating systems.

Computer 1902 can optionally comprise emulation technologies. For example, a hypervisor (not shown) or other intermediary can emulate a hardware environment for operating system 1930, and the emulated hardware can optionally be different from the hardware illustrated in FIG. 19. In such an embodiment, operating system 1930 can comprise one virtual machine (VM) of multiple VMs hosted at computer 1902. Furthermore, operating system 1930 can provide runtime environments, such as the Java runtime environment or the .NET framework, for applications 1932. Runtime environments are consistent execution environments that allow applications 1932 to run on any operating system that includes the runtime environment. Similarly, operating system 1930 can support containers, and applications 1932 can be in the form of containers, which are lightweight, standalone, executable packages of software that include, e.g., code, runtime, system tools, system libraries and settings for an application.

Further, computer 1902 can comprise a security module, such as a trusted processing module (TPM). For instance, with a TPM, boot components hash next in time boot components, and wait for a match of results to secured values, before loading a next boot component. This process can take place at any layer in the code execution stack of computer 1902, e.g., applied at the application execution level or at the operating system (OS) kernel level, thereby enabling security at any level of code execution.

A user can enter commands and information into the computer 1902 through one or more wired/wireless input devices, e.g., a keyboard 1938, a touch screen 1940, and a pointing device, such as a mouse 1942. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1904 through an input device interface 1944 that can be coupled to the system bus 1908, but can be connected by other interfaces, such as a parallel port, an IEEE serial port, a game port, a USB port, an IR interface, a BLUETOOTH® interface, etc.

A monitor 1946 or other type of display device can be also connected to the system bus 1908 via an interface, such as a video adapter 1948. In addition to the monitor 1946, a computer typically includes other peripheral output devices (not shown), such as speakers, printers, etc.

The computer 1902 can operate in a networked environment using logical connections via wired and/or wireless communications to one or more remote computers, such as a remote computer(s) 1950. The remote computer(s) 1950 can be a workstation, a server computer, a router, a personal computer, portable computer, microprocessor-based entertainment appliance, a peer device or other common network node, and typically includes many or all of the elements described relative to the computer 1902, although, for purposes of brevity, only a memory/storage device 1952 is illustrated. The logical connections depicted include wired/wireless connectivity to a local area network (LAN) 1954 and/or larger networks, e.g., a wide area network (WAN) 1956. Such LAN and WAN networking environments are commonplace in offices and companies, and facilitate enterprise-wide computer networks, such as intranets, all of which can connect to a global communications network, e.g., the internet.

When used in a LAN networking environment, the computer 1902 can be connected to the local network 1954 through a wired and/or wireless communication network interface or adapter 1958. The adapter 1958 can facilitate wired or wireless communication to the LAN 1954, which can also include a wireless access point (AP) disposed thereon for communicating with the adapter 1958 in a wireless mode.

When used in a WAN networking environment, the computer 1902 can include a modem 1960 or can be connected to a communications server on the WAN 1956 via other means for establishing communications over the WAN 1956, such as by way of the internet. The modem 1960, which can be internal or external and a wired or wireless device, can be connected to the system bus 1908 via the input device interface 1944. In a networked environment, program modules depicted relative to the computer 1902 or portions thereof, can be stored in the remote memory/storage device 1952. It will be appreciated that the network connections shown are example and other means of establishing a communications link between the computers can be used.

When used in either a LAN or WAN networking environment, the computer 1902 can access cloud storage systems or other network-based storage systems in addition to, or in place of, external storage devices 1916 as described above. Generally, a connection between the computer 1902 and a cloud storage system can be established over a LAN 1954 or WAN 1956 e.g., by the adapter 1958 or modem 1960, respectively. Upon connecting the computer 1902 to an associated cloud storage system, the external storage interface 1926 can, with the aid of the adapter 1958 and/or modem 1960, manage storage provided by the cloud storage system as it would other types of external storage. For instance, the external storage interface 1926 can be configured to provide access to cloud storage sources as if those sources were physically connected to the computer 1902.

The computer 1902 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

FIG. 20 is a schematic block diagram of a sample computing environment 2000 with which the disclosed subject matter can interact. The sample computing environment 2000 includes one or more client(s) 2002. The client(s) 2002 can be hardware and/or software (e.g., threads, processes, computing devices). The sample computing environment 2000 also includes one or more server(s) 2004. The server(s) 2004 can also be hardware and/or software (e.g., threads, processes, computing devices). The servers 2004 can house threads to perform transformations by employing one or more embodiments as described herein, for example. One possible communication between a client 2002 and servers 2004 can be in the form of a data packet adapted to be transmitted between two or more computer processes. The sample computing environment 2000 includes a communication framework 2006 that can be employed to facilitate communications between the client(s) 2002 and the server(s) 2004. The client(s) 2002 are operably connected to one or more client data store(s) 2008 that can be employed to store information local to the client(s) 2002. Similarly, the server(s) 2004 are operably connected to one or more server data store(s) 2010 that can be employed to store information local to the servers 2004.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive-in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

As used in this disclosure, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

It is to be understood that when an element is referred to as being “coupled” to another element, it can describe one or more different types of coupling including, but not limited to, chemical coupling, communicative coupling, electrical coupling, electromagnetic coupling, operative coupling, optical coupling, physical coupling, thermal coupling, and/or another type of coupling. Likewise, it is to be understood that when an element is referred to as being “connected” to another element, it can describe one or more different types of connecting including, but not limited to, electrical connecting, electromagnetic connecting, operative connecting, optical connecting, physical connecting, thermal connecting, and/or another type of connecting.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

The term “facilitate” as used herein is in the context of a system, device or component “facilitating” one or more actions or operations, in respect of the nature of complex computing environments in which multiple components and/or multiple devices can be involved in some computing operations. Non-limiting examples of actions that may or may not involve multiple components and/or multiple devices comprise transmitting or receiving data, establishing a connection between devices, determining intermediate results toward obtaining a result, etc. In this regard, a computing device or component can facilitate an operation by playing any part in accomplishing the operation. When operations of a component are described herein, it is thus to be understood that where the operations are described as facilitated by the component, the operations can be optionally completed with the cooperation of one or more other computing devices or components, such as, but not limited to, sensors, antennae, audio and/or visual output devices, other devices, etc.

Further, the various embodiments can be implemented as a method, apparatus or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

Moreover, terms such as “mobile device equipment,” “mobile station,” “mobile,” “subscriber station,” “access terminal,” “terminal,” “handset,” “communication device,” “mobile device” (and/or terms representing similar terminology) can refer to a wireless device utilized by a subscriber or mobile device of a wireless communication service to receive or convey data, control, voice, video, sound, gaming or substantially any data-stream or signaling-stream. The foregoing terms are utilized interchangeably herein and with reference to the related drawings. Likewise, the terms “access point (AP),” “Base Station (BS),” “BS transceiver,” “BS device,” “cell site,” “cell site device,” “gNode B (gNB),” “evolved Node B (eNode B, eNB),” “home Node B (HNB)” and the like, refer to wireless network components or appliances that transmit and/or receive data, control, voice, video, sound, gaming or substantially any data-stream or signaling-stream from one or more subscriber stations. Data and signaling streams can be packetized or frame-based flows.

Furthermore, the terms “device,” “communication device,” “mobile device,” “subscriber,” “client entity,” “consumer,” “client entity,” “entity” and the like are employed interchangeably throughout, unless context warrants particular distinctions among the terms. It should be appreciated that such terms can refer to human entities or automated components supported through artificial intelligence (e.g., a capacity to make inference based on complex mathematical formalisms), which can provide simulated vision, sound recognition and so forth.

It should be noted that although various aspects and embodiments are described herein in the context of 5G or other next generation networks, the disclosed aspects are not limited to a 5G implementation, and can be applied in other network next generation implementations, such as sixth generation (6G), or other wireless systems. In this regard, aspects or features of the disclosed embodiments can be exploited in substantially any wireless communication technology. Such wireless communication technologies can include universal mobile telecommunications system (UMTS), global system for mobile communication (GSM), code division multiple access (CDMA), wideband CDMA (WCMDA), CDMA2000, time division multiple access (TDMA), frequency division multiple access (FDMA), multi-carrier CDMA (MC-CDMA), single-carrier CDMA (SC-CDMA), single-carrier FDMA (SC-FDMA), orthogonal frequency division multiplexing (OFDM), discrete Fourier transform spread OFDM (DFT-spread OFDM), filter bank based multi-carrier (FBMC), zero tail DFT-spread-OFDM (ZT DFT-s-OFDM), generalized frequency division multiplexing (GFDM), fixed mobile convergence (FMC), universal fixed mobile convergence (UFMC), unique word OFDM (UW-OFDM), unique word DFT-spread OFDM (UW DFT-Spread-OFDM), cyclic prefix OFDM (CP-OFDM), resource-block-filtered OFDM, wireless fidelity (Wi-Fi), worldwide interoperability for microwave access (WiMAX), wireless local area network (WLAN), general packet radio service (GPRS), enhanced GPRS, third generation partnership project (3GPP), long term evolution (LTE), 5G, third generation partnership project 2 (3GPP2), ultra-mobile broadband (UMB), high speed packet access (HSPA), evolved high speed packet access (HSPA+), high-speed downlink packet access (HSDPA), high-speed uplink packet access (HSUPA), Zigbee, or another institute of electrical and electronics engineers (IEEE) 802.12 technology.

The following provides an overview of various concepts presented herein.

1. A system, located on a first vehicle being driven at least partially autonomously, comprising a memory that stores computer executable components; and a processor that executes the computer executable components stored in the memory, wherein the computer executable components comprise: a motion component configured to assess operation of a second vehicle driving ahead of the first vehicle; a road condition component configured to identify a road condition based on the operation of the second vehicle; and a navigation component configured to navigate the first vehicle around or over the road condition.

2. The system of claim 1, wherein the road condition is one of a pothole, a speed bump, or road debris.

3. The system of claim 1, further comprising: a camera configured to provide imagery of the second vehicle; and an algorithm configured to extract at least one of a license plate of the second vehicle, a manufacturer of the second vehicle, a model type of the second vehicle, a height of a structure on the second vehicle, a width of the second vehicle, or an axle width of the second vehicle.

4. The system of any preceding claim, further comprising: an onboard vehicle database comprising license plates associated with manufacturers and models of vehicles; and an onboard computer system configured: to identify the license plate in the vehicle database; determine the model type of the second vehicle based on a model type assigned to the license plate in the vehicle database; and determine at least one dimension of the second vehicle, wherein the at least one dimension is one of the height of the structure on the second vehicle, the width of the second vehicle, or the axle width of the second vehicle.

5. The system of claim 1, wherein the road condition component is further configured to determine at least one of a depth of the road condition below a road surface or a height of the road condition above the road surface based on a change in an alignment of the second vehicle relative to the road surface.

6. The system of any preceding claim, further comprising; a camera configured to provide imagery of road being navigated by the first and second vehicle; the road condition component is further configured to execute an algorithm configured to: analyze the imagery; identify at least a first lane marking on the road; and determine a passable distance between an edge of the road condition and the first lane marking; and an avoidance component configured to determine whether the road condition can be navigated around based on the passable distance.

7. The system of any preceding claim, wherein the avoidance component is further configured to determine whether the road condition can be navigated around based upon whether an axle width of the first vehicle is narrower than the passable distance.

8. The system of any preceding claim, wherein the avoidance component is further configured to: identify whether a lane is adjacent to the lane currently being driven by the first vehicle; and in response to determining an adjacent lane exists, steer the first vehicle into the adjacent lane to avoid the road condition.

9. The system of claim 1, further comprising a communications component configured to transmit information compiled by the road condition component regarding the road condition, wherein the information is transmitted to a system remotely located to the first vehicle.

10. A computer-implemented method for identifying a road condition on a road being navigated by an autonomous vehicle (AV) comprising: monitoring operation of a lead vehicle, wherein the lead vehicle is operating ahead of the AV on the road; based on operation of the lead vehicle, determining the road condition exists; and determining a direction to drive by or over the road condition mitigating damage to the AV.

11. The computer-implemented method of claim 10, wherein the road condition is one of a pothole, a speed bump, or road debris.

12. The computer-implemented method of any preceding claim, further comprising: determining a dimension of the road condition based upon at least one of a change in alignment of the lead vehicle relative to a surface of the road or a vertical deflection of a structure on the lead vertical relative to the road surface, wherein the dimension is one of a depth of a pothole, a height of road debris, or a height of a speed bump.

13. The computer-implemented method of claim 10, further comprising: identifying at least one of a make or model of the lead vehicle based on a license plate located on the lead vehicle or a manufacturer identifier located on the lead vehicle.

14. The computer-implemented method of claim 10, further comprising: receiving video imagery of the lead vehicle; and determining at least one of a size, width, or axle width of the lead vehicle based on the received video imagery.

15. The computer-implemented method of claim 10, wherein the lead vehicle occludes detection of the road condition by one or more sensors located onboard the AV.

16. The computer-implemented method of claim 10, further comprising: transmitting information obtained by the AV regarding the road condition to a remotely located system to facilitate informing at least one of another AV, driver, road maintenance department, global positioning system (GPS) provider, or police force of at least one of the presence or magnitude of the road condition.

17. A computer program product comprising a computer readable storage medium having program instructions embodied therewith, the program instructions executable by a processor to cause the processor to: determine a road condition based on operation of a lead vehicle navigating a road being navigated by an autonomous vehicle (AV), wherein the AV is driving behind the lead vehicle, and the processer is located on the AV; and control navigation of the road condition by the AV, based in part on how the lead vehicle navigated the road condition.

18. The computer program product of claim 17, where the program instructions are further executable to the processor to cause the processor to: determine a magnitude of the road condition based upon at least one of a vertical displacement of the lead vehicle relative to a surface of the road or a change in alignment of the lead vehicle relative to the road surface.

19. The computer program product of claim 17, wherein the program instructions are further executable by the processor to cause the processor to: determine whether the road condition can be navigated while remaining in a current lane of the road; and in response to determining that it is not possible to navigate around the road condition while remaining in the current lane of the road, navigating the AV into an adjacent lane to navigate the road condition.

20. The computer program product of claim 17, wherein the program instructions are further executable by the processor to cause the processor to: transmit information regarding the road condition to a system remotely located to the AV.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A system, located on a first vehicle being driven at least partially autonomously, comprising:
a memory that stores computer executable components; and
a processor that executes the computer executable components stored in the memory, wherein the computer executable components comprise:
a motion component configured to assess operation of a second vehicle driving ahead of the first vehicle;
a road condition component configured to identify a road condition based on the operation of the second vehicle; and
a navigation component configured to navigate the first vehicle around or over the road condition.

2. The system of claim 1, wherein the road condition is one of a pothole, a speed bump, or road debris.

3. The system of claim 1, further comprising:
a camera configured to provide imagery of the second vehicle; and
an algorithm configured to extract at least one of a license plate of the second vehicle, a manufacturer of the second vehicle, a model type of the second vehicle, a height of a structure on the second vehicle, a width of the second vehicle, or an axle width of the second vehicle.

4. The system of claim 3, further comprising:
an onboard vehicle database comprising license plates associated with manufacturers and models of vehicles; and
an onboard computer system configured:
to identify the license plate in the vehicle database;
determine the model type of the second vehicle based on a model type assigned to the license plate in the vehicle database; and
determine at least one dimension of the second vehicle, wherein the at least one dimension is one of the height of the structure on the second vehicle, the width of the second vehicle, or the axle width of the second vehicle.

5. The system of claim 1, wherein the road condition component is further configured to determine at least one of a depth of the road condition below a road surface or a height of the road condition above the road surface based on a change in an alignment of the second vehicle relative to the road surface.

6. The system of claim 5, further comprising;
a camera configured to provide imagery of road being navigated by the first and second vehicle;
the road condition component is further configured to execute an algorithm configured to:
analyze the imagery;
identify at least a first lane marking on the road; and
determine a passable distance between an edge of the road condition and the first lane marking; and
an avoidance component configured to determine whether the road condition can be navigated around based on the passable distance.

7. The system of claim 6, wherein the avoidance component is further configured to determine whether the road condition can be navigated around based upon whether an axle width of the first vehicle is narrower than the passable distance.

8. The system of claim 6, wherein the avoidance component is further configured to:
identify whether a lane is adjacent to the lane currently being driven by the first vehicle; and
in response to determining an adjacent lane exists, steer the first vehicle into the adjacent lane to avoid the road condition.

9. The system of claim 1, further comprising a communications component configured to transmit information compiled by the road condition component regarding the road condition, wherein the information is transmitted to a system remotely located to the first vehicle.

10. A computer-implemented method for identifying a road condition on a road being navigated by an autonomous vehicle (AV) comprising:
monitoring operation of a lead vehicle, wherein the lead vehicle is operating ahead of the AV on the road;
based on operation of the lead vehicle, determining the road condition exists; and
determining a direction to drive by or over the road condition mitigating damage to the AV.

11. The computer-implemented method of claim 10, wherein the road condition is one of a pothole, a speed bump, or road debris.

12. The computer-implemented method of claim 11, further comprising:
determining a dimension of the road condition based upon at least one of a change in alignment of the lead vehicle relative to a surface of the road or a vertical deflection of a structure on the lead vertical relative to the road surface, wherein the dimension is one of a depth of a pothole, a height of road debris, or a height of a speed bump.

13. The computer-implemented method of claim 10, further comprising:
identifying at least one of a make or model of the lead vehicle based on a license plate located on the lead vehicle or a manufacturer identifier located on the lead vehicle.

14. The computer-implemented method of claim 10, further comprising:
receiving video imagery of the lead vehicle; and
determining at least one of a size, width, or axle width of the lead vehicle based on the received video imagery.

15. The computer-implemented method of claim 10, wherein the lead vehicle occludes detection of the road condition by one or more sensors located onboard the AV.

16. The computer-implemented method of claim 10, further comprising:
transmitting information obtained by the AV regarding the road condition to a remotely located system to facilitate informing at least one of another AV, driver, road maintenance department, global positioning system (GPS) provider, or police force of at least one of the presence or magnitude of the road condition.

17. A computer program product comprising a computer readable storage medium having program instructions embodied therewith, the program instructions executable by a processor to cause the processor to:
determine a road condition based on operation of a lead vehicle navigating a road being navigated by a first vehicle, wherein the first vehicle is driving behind the lead vehicle, and the processer is located on the first vehicle; and
control navigation of the road condition by the first vehicle, based in part on how the lead vehicle navigated the road condition.

18. The computer program product of claim 17, where the program instructions are further executable to the processor to cause the processor to:
determine a magnitude of the road condition based upon at least one of a vertical displacement of the lead vehicle relative to a surface of the road or a change in alignment of the lead vehicle relative to the road surface.

19. The computer program product of claim 17, wherein the program instructions are further executable by the processor to cause the processor to:
determine whether the road condition can be navigated while remaining in a current lane of the road; and
in response to determining that it is not possible to navigate around the road condition while remaining in the current lane of the road, navigating the first vehicle into an adjacent lane to navigate the road condition.

20. The computer program product of claim 17, wherein the first vehicle is being operated in one of an autonomous, a partially autonomous, or a non-autonomous manner and the lead vehicle is being operated in one of an autonomous, a partially autonomous, or a non-autonomous manner.
